(19) United States
(12) Patent Application Publication
(10) Pub. No.: US 2018/0004017 A1
(43) Pub. Date: Jan. 4, 2018

(54) Display Device

(71) Applicant: Semiconductor Energy Laboratory Co., Ltd., Kanagawa-ken (JP)

(72) Inventors: Ryo Hatsumi, Hadano (JP); Daisuke Kubota, Atsugi (JP)

(73) Assignee: Semiconductor Energy Laboratory Co., Ltd., Kanagawa-ken (JP)

(21) Appl. No.: 15/636,962

(22) Filed: Jun. 29, 2017

(30) Foreign Application Priority Data
Jul. 1, 2016 (JP) 2016-131938

(51) Int. Cl. G02F 1/00; G02F 1/01; G02F 1/1333; G02F 1/1347

(52) U.S. Cl. CPC G02F 1/0045; G02F 1/133305; G02F 1/01; G02F 1/0063; G02F 1/13475

(57) ABSTRACT

A display device is provided which has high visibility by including a display element and a polarizer between a pair of substrates. The display element includes a liquid crystal element and/or a light-emitting element. The display device includes an element layer between a pair of substrates, and an organic layer serving as a polarizer or both the organic layer and a retardation layer between the element layer and the second substrate. The organic layer includes a dichroic dye in which the major axes of molecules are oriented in one predetermined direction.

### TECHNICAL FIELD

One embodiment of the present invention relates to a display device. Note that one embodiment of the present invention is not limited thereto. That is, one embodiment of the present invention relates to an object, a method, a manufacturing method, or a driving method. In addition, one embodiment of the present invention relates to a process, a machine, manufacture, or a composition of matter. As specific examples, a semiconductor device, a light-emitting device, a liquid crystal display device, a lighting device, and the like can be given.

### BACKGROUND ART

As display devices, a liquid crystal display device including a liquid crystal element and a light-emitting device including a light-emitting element (EL element) are known. For example, in a liquid crystal display device, a liquid crystal element including a liquid crystal material is interposed between a pair of electrodes facing each other with alignment films provided between the liquid crystal element and the electrodes, and the liquid crystal display device displays images by utilizing the optical modulation action of the liquid crystal. A light-emitting device includes a light-emitting element in which an EL layer containing a light-emitting body is interposed between a pair of electrodes, and displays images by utilizing light emission that occurs when carriers (electrons and holes) that are injected from the electrodes by voltage application to the light-emitting element are recombined in the emission center of the EL layer.

When a liquid crystal element is employed as a display element, a polarizing plate and a retardation film are necessary for display and are bonded to the outside of a light-transmitting substrate provided with the liquid crystal element, for example (e.g., see Patent Document 1). Specifically, when a reflective liquid crystal element is used under an environment with strong external light, reflection of the external light significantly reduces visibility and thus, a polarizing plate that is a polarizer is indispensable.

Also in the case of employing a light-emitting element, when a metal film forming a wiring or the like reflects external light on a surface through which light from the light-emitting element is emitted, a polarizing plate needs to be provided, for example, on a surface of a substrate on which external light is reflected.

In the case where a polarizing plate that absorbs external light, which is needed in order to prevent reflection of external light as described above, is provided on a substrate surface in the above-described manner, the polarizing plate is formed on the entire substrate surface and it is difficult to provide the polarizing plate on part of the substrate. In that case, while reflection of external light can be prevented, the luminance of light emission from a display element is reduced. In addition, when a polarizing plate is provided on a substrate surface, the polarizing plate is easily deteriorated by external impact or the like.

### REFERENCE

### Patent Document

### [Patent Document 1] Japanese Published Patent Application No. 2013-120319

### DISCLOSURE OF INVENTION

In view of the above, one embodiment of the present invention provides a display device in which a display element (a liquid crystal element and/or a light-emitting element) is provided between a pair of substrates and which achieves high visibility because of a polarizer between the pair of substrates. One embodiment of the present invention provides a display device that is partly provided with a polarizer depending on the characteristics of a display element. One embodiment of the present invention provides a display device that inhibits reflection of external light and achieves high visibility under an environment with strong external light. One embodiment of the present invention provides a display device with low power consumption.

Note that the descriptions of these objects do not disturb the existence of other objects. In one embodiment of the present invention, there is no need to achieve all the objects. Other objects will be apparent from and can be derived from the description of the specification, the drawings, the claims, and the like.

One embodiment of the present invention is a display device that includes an element layer between a pair of substrates (a first substrate and a second substrate), and an organic layer serving as a polarizer or both the organic layer and a retardation layer between the element layer and the second substrate. The above element layer includes, for example, a display element layer that includes a display element such as a transmissive liquid crystal element, a reflective liquid crystal element, a light-emitting element, or a MEMS element; and a driving element layer that includes a transistor (FET) or the like for driving such a display element.

Note that the organic layer contains a dichroic dye in which the major axes of molecules are oriented in one predetermined direction. Accordingly, the organic layer serves as a polarizer. Note that a liquid crystal material is used to orient the major axes of the molecules of the dichroic dye in one predetermined direction. After the major axes of the molecules are oriented in one predetermined direction with the liquid crystal material, a monomer (or a liquid crystalline monomer) that is added together with the dichroic dye is cured to be polymerized. Therefore, the organic layer in one embodiment of the present invention contains a dichroic dye in which the major axes of molecules are oriented in one predetermined direction, a liquid crystal material, and a polymer (when a liquid crystalline polymer is used, the dichroic dye and the liquid crystalline polymer).

One embodiment of the present invention is a display device that includes an element layer between a first substrate and a second substrate; a retardation layer between the second substrate and the element layer; and an organic layer between the second substrate and the retardation layer. The element layer includes a liquid crystal element. The organic layer includes a dichroic dye in which major axes of molecules are oriented in one predetermined direction. The organic layer and the retardation layer are positioned to overlap with the liquid crystal element.

In the above structure, the second substrate includes a material transmitting visible light, and the liquid crystal element is a reflective liquid crystal element from which light is emitted to the second substrate side.

Another embodiment of the present invention is a display device that includes an element layer between a first substrate and a second substrate; a retardation layer between the second substrate and the element layer; and an organic layer between the second substrate and the retardation layer. The organic layer includes a first organic layer and a second organic layer. The first organic layer includes a material with a light-transmitting property. The second organic layer includes a dichroic dye in which major axes of molecules are oriented in one predetermined direction. The element layer includes a light-emitting element, a driving element, and a wiring. The light-emitting element and the driving element are electrically connected through the wiring. The first organic layer is positioned to overlap with the light-emitting element. The second organic layer is positioned to overlap with the wiring.

In the above structure, the light-emitting element emits light to the second substrate side.

In any of the above structures, the light-emitting element includes an EL layer between an anode and a cathode, and light emitted in the EL layer is transmitted through the anode and emitted from the second substrate side.

In any of the above structures, the EL layer has a stacked-layer structure in which a charge generation layer is provided between a first EL layer and a second EL layer, and the EL layer is positioned to overlap with the first organic layer.

Another embodiment of the present invention is a display device that includes an element layer between a first substrate and a second substrate; a retardation layer between the second substrate and the element layer; and an organic layer between the second substrate and the retardation layer. The organic layer includes a first organic layer and a second organic layer. The first organic layer includes a material with a light-transmitting property. The second organic layer includes a dichroic dye in which major axes of molecules are oriented in one predetermined direction. The element layer includes a liquid crystal element, a light-emitting element, a driving element, and a wiring. The driving element is electrically connected to each of the liquid crystal element and the light-emitting element through the wiring. The first organic layer is positioned to overlap with the light-emitting element. The second organic layer is positioned to overlap with the liquid crystal element and the wiring.

In the above structure, not only the liquid crystal element and the wiring but also the driving element may be positioned to overlap with the second organic layer.

In any of the above structures, the second organic layer includes a liquid crystalline polymer, or a liquid crystal and a polymer. Note that a liquid crystalline polymer is a polymer with a structure in which a main chain or a side chain exhibits liquid crystallinity.

The dichroic dye in any of the above structures is a dye in which the absorbance with respect to incident light in the major axis direction of a molecule is different from that with respect to incident light in the minor axis direction of the molecule. As examples of the dichroic dye, organic compounds represented by Structural Formulae (101) to (105) can be given. Note that the dichroic dye in the above structures is not limited to the compounds below.

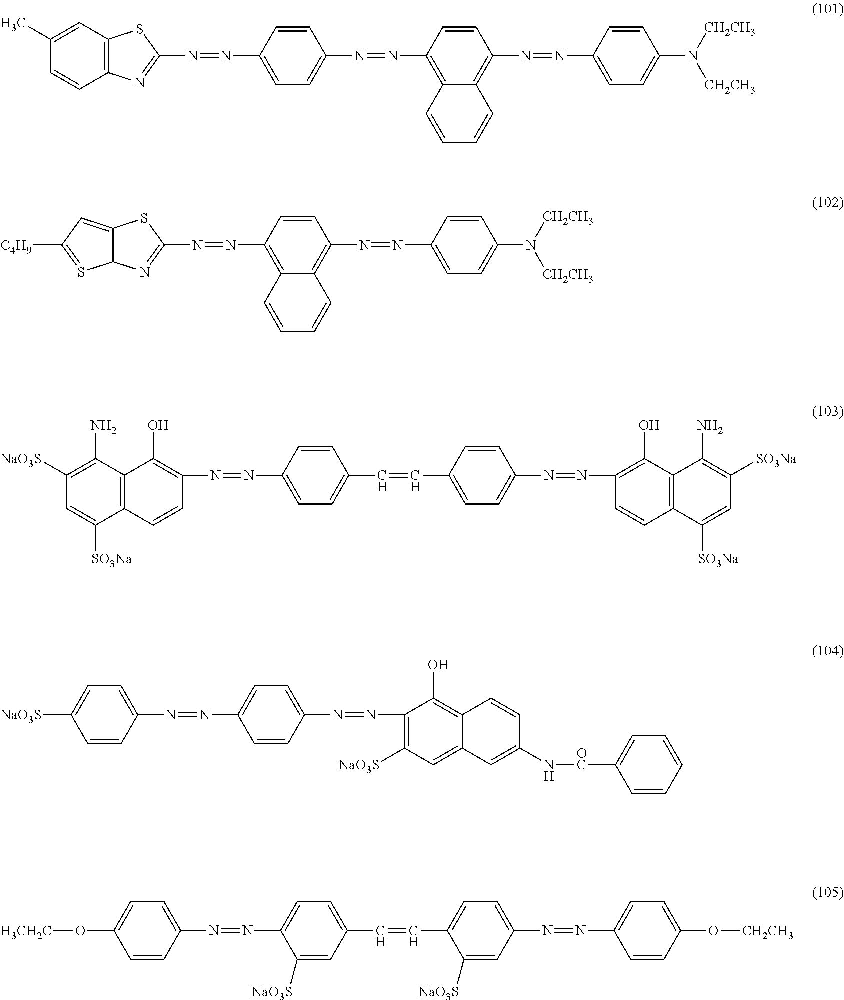

Another embodiment of the present invention is an electronic device that includes the display device having any one of the above structures and an operation key, a speaker, a microphone, or an external connection portion.

Note that one embodiment of the present invention includes, in its category, in addition to a display device including a liquid crystal element and a light-emitting element, an electronic device including a display device (specifically, an electronic device including a display device, a connection terminal, or an operation key). Therefore, a display device in this specification refers to an image display device. In addition, the display device includes any of the following modules in its category: a module in which a connector such as a flexible printed circuit (FPC) or a tape carrier package (TCP) is attached to a display device; a module having a TCP provided with a printed wiring board at the end thereof; and a module in which an integrated circuit (IC) is directly mounted.

According to one embodiment of the present invention, it is possible to provide a display device in which a display element (a liquid crystal element and/or a light-emitting element) is provided between a pair of substrates and which achieves high visibility because of a polarizer between the pair of substrates. According to one embodiment of the present invention, it is possible to provide a display device that is partly provided with a polarizer depending on the characteristics of a display element. According to one embodiment of the present invention, it is possible to provide a display device that inhibits reflection of external light and achieves high visibility under an environment with strong external light. According to one embodiment of the present invention, it is possible to provide a display device with low power consumption that can perform bright display because the emission luminance of a light-emitting element is not reduced by a polarizer.

Note that the description of these effects does not preclude the existence of other effects. One embodiment of the present invention does not necessarily achieve all the effects listed above. Other effects will be apparent from and can be derived from the description of the specification, the drawings, the claims, and the like.

### BRIEF DESCRIPTION OF DRAWINGS

FIGS. 1A to 1D illustrate display devices of embodiments of the present invention.

FIGS. 2A to 2C illustrate a display device of one embodiment of the present invention.

FIGS. 3A to 3C illustrate a display device of one embodiment of the present invention.

FIGS. 4A to 4D illustrate display devices of embodiments of the present invention.

FIGS. 5A and 5B illustrate a display device of one embodiment of the present invention.

FIGS. 6A to 6E illustrate a display device of one embodiment of the present invention.

FIGS. 7A, 7B1, and 7B2 illustrate a display device of one embodiment of the present invention.

FIG. 8 illustrates a display device of one embodiment of the present invention.

FIGS. 9A, 9B, 9C, 9D, 9D′-1, 9D′-2, and 9E illustrate electronic devices.

FIGS. 10A to 10C illustrate an electronic device.

FIGS. 11A and 11B illustrate an automobile.

FIG. 12 is a graph showing the degree of polarization (%) of an organic layer as a function of wavelength.

FIG. 13 is a graph showing the relationship between the degree of polarization (%) and transmittance (%) of an organic layer.

### BEST MODE FOR CARRYING OUT THE INVENTION

Embodiments of the present invention will be described below with reference to the drawings. Note that one embodiment of the present invention is not limited to the following description, and the mode and details can be variously changed unless departing from the scope and spirit of the present invention. Thus, the present invention should not be construed as being limited to the description in the following embodiments.

Note that the position, size, range, or the like of each component illustrated in the drawings and the like are not accurately represented in some cases for easy understanding. Therefore, the disclosed invention is not necessarily limited to the position, size, range, or the like disclosed in the drawings and the like.

In describing structures of the present invention with reference to the drawings, the same reference numerals are used in common for the same portions in different drawings in this specification and the like.

### Embodiment 1

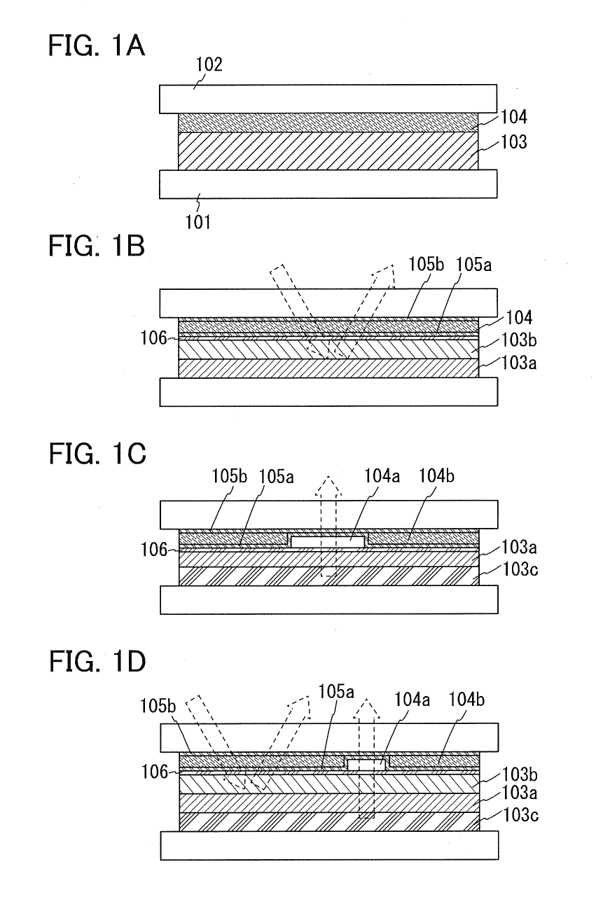

In this embodiment, one example of a display device which is one embodiment of the present invention will be described with reference to FIGS. 1A to 1D.

The display device in FIG. 1A includes an element layer 103 between a first substrate 101 and a second substrate 102, and an organic layer 104 serving as a polarizer between the second substrate 102 and the element layer 103.

The first substrate 101 and/or the second substrate 102 are/is a substrate with a light-transmitting property. In other words, substrates are selected such that light from a display element included in the element layer 103 can be at least emitted to the outside.

Note that the type of the substrate is not limited to a certain type. Examples of the substrate include a semiconductor substrate (e.g., a single crystal substrate or a silicon substrate), an SOI substrate, a glass substrate, a quartz substrate, a plastic substrate, a metal substrate, a stainless steel substrate, a substrate including stainless steel foil, a tungsten substrate, a substrate including tungsten foil, a flexible substrate, an attachment film, paper including a fibrous material, and a base material film.

The element layer 103 includes, for example, a display element layer that includes a display element such as a transmissive liquid crystal element, a reflective liquid crystal element, a light-emitting element, or a MEMS element; and a driving element layer that includes a transistor (FET) or the like for driving such a display element. Note that the display element formed in the display element layer and the driving element formed in the driving element layer are electrically connected through a wiring. The display element layer and the driving element layer may be separately formed and then stacked. In the case where a plurality of kinds of display elements (e.g., a liquid crystal element and a light-emitting element) are provided, they may be formed in the respective layers and then stacked using a separation technique and a bonding technique.

The organic layer 104 serves as a polarizer and contains a dichroic dye in which the major axes of molecules are oriented in one predetermined direction. Note that an azo compound having a benzothiazole group, a thienothiazole group, or a stilbene group can be used as the dichroic dye. Specifically, for example, dichroic dyes represented by Structural Formulae (101) to (105) can be used.

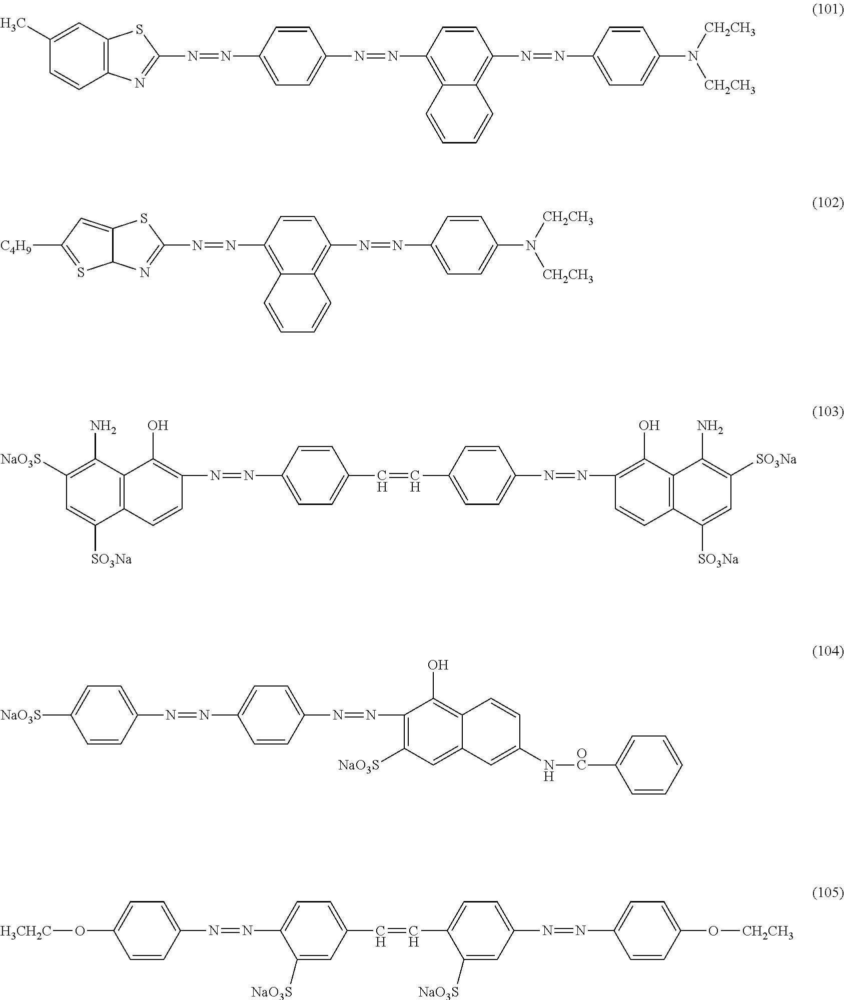

As described above, in the organic layer 104, the dichroic dye maintains the state in which the major axes of the molecules are oriented in one predetermined direction. Thus, when the major axes of the molecules in the dichroic dye are oriented in a predetermined direction in a medium and then, the medium is cured, the orientation in the dichroic dye is maintained. As the medium, a liquid crystal material for orientation of the major axes of the molecules in the dichroic dye and a photocurable (ultraviolet curable) or thermosetting monomer can be used (note that when the liquid crystal material is a liquid crystalline monomer, another monomer does not always need to be used). Therefore, the organic layer 104 after curing the monomer contains the dichroic dye, the liquid crystal material (which may be a liquid crystalline polymer), and in some cases, a polymer.

Examples of a liquid crystal material that can be used as the medium include a nematic liquid crystal, a cholesteric liquid crystal, a smectic liquid crystal, a discotic liquid crystal, a ferroelectric liquid crystal, an anti-ferroelectric liquid crystal, and a banana-shaped liquid crystal. When a liquid crystalline monomer is used as the liquid crystal material, a photocurable (ultraviolet curable) liquid crystal material or a thermosetting liquid crystal material can be used. Furthermore, either a positive liquid crystal or a negative liquid crystal can be used. Specific examples of the liquid crystalline monomer include 1,4-bis-[4-(9-acryloyloxynonyloxy)benzoyloxy]-2-methylbenzene represented by Structural Formula (201) and 1-acryloyloxy-4-(trans-4-n-propylcyclohexyl)benzene represented by Structural Formula (202).

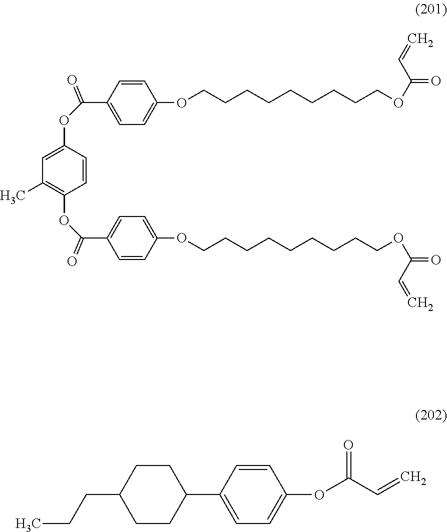 [SMILES: C=CC(=O)OCCCCCCCCCOc1ccc(C(=O)Oc2ccc(OC(=O)c3ccc(OCCCCCCCCCOC(=O)C=C)cc3)c(C)c2)cc1 ; C=CC(=O)Oc1ccc(C2CCC(CCC)CC2)cc1]

The organic layer 104 can be formed by applying and curing a solution containing a dichroic dye and the above-described medium. Therefore, although not illustrated in FIG. 1A, to make the major axes of the molecules in the dichroic dye contained in the organic layer 104 have orientation in a predetermined direction, it is preferable that an alignment film be formed over a surface to which the solution containing the dichroic dye and the above-described medium is applied (a surface in contact with the organic layer 104) or the like and be subjected to rubbing treatment.

Therefore, the organic layer 104 formed by curing the above solution contains the dichroic dye and a liquid crystalline polymer or contains the dichroic dye, a liquid crystal, and a polymer.

In the display device illustrated in FIG. 1B, an element layer has a structure in which a driving element layer 103a and a display element layer (L) 103b are stacked. Specifically, the display element layer (L) 103b includes a reflective liquid crystal element as a display element.

Alignment films (105a and 105b) illustrated in FIG. 1B are provided to orient the major axes of the molecules in the dichroic dye of the organic layer 104. A material formed using rubbing treatment or an optical alignment technique is preferably used for the alignment films (105a and 105b). For the alignment films (105a and 105b), a material containing a polyimide or the like can be used.

Since the display element layer (L) 103b illustrated in FIG. 1B is a reflective liquid crystal element, a retardation layer 106 is provided between the alignment film 105a and the display element layer (L) 103b. Thus, in the structure illustrated in FIG. 1B, as indicated by an arrow, light incident from the outside is transmitted through the organic layer 104 and the retardation layer 106, then reflected by a reflective electrode of the liquid crystal element in the display element layer (L) 103b, transmitted through the retardation layer 106 and the organic layer 104 again, and emitted to the outside.

Note that the retardation layer 106 serves as a birefringence element that causes a phase difference between polarization components that are at right angles to each other. Therefore, a combination of the organic layer 104 and the retardation layer 106 enables a wide viewing angle in the case where a liquid crystal element is used as a display element.

As the retardation layer 106, for example, an optical film that is obtained by processing a resin by monoaxial stretching, biaxial stretching, or the like can be used. Alternatively, the retardation layer 106 can be formed by film formation. Specific examples of the material used for the retardation layer 106 include cyclo-olefin polymer (COP), polycarbonate (PC), polymethyl methacrylate (PMMA), polystyrene (PS), polyether sulfone (PES), polyphenylene sulfide (PPS), polyethylene terephthalate (PET), polyethylene naphthalate (PEN), polypropylene (PP), polyphenylene oxide (PPO), polyarylate (PAR), polyimide (PI), and polytetrafluoroethylene (PTFE).

In the display device illustrated in FIG. 1C, an element layer has a structure in which the driving element layer 103a and a display element layer (E) 103c are stacked. Specifically, the display element layer (E) 103c includes a light-emitting element (which may be an organic EL element) as a display element. Note that in the case of the display device illustrated in FIG. 1C, the organic layer 104 in FIGS. 1A and 1B includes a first organic layer 104a with a light-transmitting property and a second organic layer 104b serving as a polarizer.

The first organic layer 104a has a light-transmitting property and thus is provided to overlap with a position in which light from the light-emitting element in the display element layer (E) 103c is emitted to the outside. Therefore, as indicated by an arrow in FIG. 1C, light from the light-emitting element in the display element layer (E) 103c is, after being transmitted through the driving element layer 103a, transmitted through the first organic layer 104a to be emitted to the outside.

The first organic layer 104a is formed using an organic material with a light-transmitting property. Note that the material with a light-transmitting property is preferably a material having a light-transmitting property with respect to visible light (e.g., a visible light transmittance of 40% or more), examples of which include organic substances such as an acrylic and a polyimide and inorganic substances such as SiON and SiN. In addition, a combination thereof may be used. The first organic layer 104a is formed in such a manner that a photosensitive acrylic that is a material is applied onto a formation surface and then patterned by light exposure using a mask. Then, development and baking are performed to selectively form an organic layer in only a desired part. Note that the shape can be any required shape, e.g., a conical shape or a pyramidal shape.

By being stacked with the retardation layer 106, the second organic layer 104b in FIG. 1C can prevent reflection of external light by a high-reflectance material (which is contained in a wiring, a driving element, a light-emitting element, or the like) in the driving element layer 103a or the display element layer (E) 103c. Thus, like the organic layer 104 in FIGS. 1A and 1B, the second organic layer 104b is formed using a dichroic dye, a liquid crystal material that orients the major axes of the molecules in the dichroic dye and cures the dichroic dye, and a monomeric material (when a liquid crystalline monomer is used, the dichroic dye and the liquid crystalline monomer). To orient the major axes of the molecules in the dichroic dye and the liquid crystal material (which may be the liquid crystalline monomer) at the time of formation of the second organic layer 104b, the alignment films (105a and 105b) are formed in contact with the second organic layer 104b.

In the display device illustrated in FIG. 1D, an element layer has a structure in which the driving element layer 103a, the display element layer (L) 103b, and the display element layer (E) 103c are stacked. The display element layer (L) 103b includes a reflective liquid crystal element as a display element, and the display element layer (E) 103c includes a light-emitting element (which may be an organic EL element) as a display element. Note that the alignment films (105a and 105b), the first organic layer 104a, and the second organic layer 104b in FIG. 1D are formed as in FIG. 1C.

The first organic layer 104a in FIG. 1D has a light-transmitting property and is provided in part of the organic layer to overlap with a position in which light from the light-emitting element in the display element layer (E) 103c is emitted to the outside. Therefore, as indicated by an arrow, light from the light-emitting element in the display element layer (E) 103c is, after being transmitted through the driving element layer 103a and the display element layer (L) 103b, transmitted through the first organic layer 104a. By being used in combination with the retardation layer 106, the second organic layer 104b can prevent reflection of external light by a high-reflectance material (which is contained in a wiring, a reflective electrode, a driving element, a light-emitting element, or the like) in the driving element layer 103a, the display element layer (L) 103b, or the display element layer (E) 103c.

As described above and illustrated in FIGS. 1A to 1D, the element layer 103 having a single-layer structure or a stacked-layer structure is provided between the first substrate 101 and the second substrate 102, and the organic layer 104, or the organic layer 104 and the retardation layer 106 is/are provided between the second substrate 102 and the element layer 103. In this manner, reflection of external light is inhibited and high visibility is achieved. Alternatively, the emission luminance of the light-emitting element is not reduced by a polarizer, which leads to bright display and low power consumption of the display device.

Note that the structure shown in this embodiment can be combined with the structure shown in the other embodiments as appropriate.

### Embodiment 2

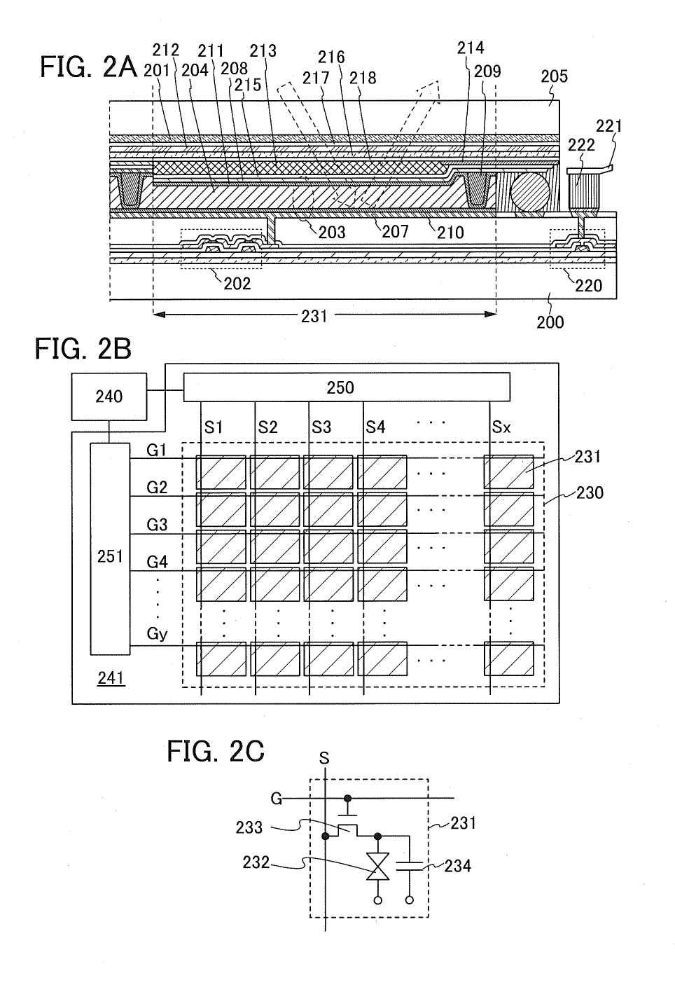

In this embodiment, a display device including a reflective liquid crystal element, which is an example of a display device whose element layer includes a display element having a function of controlling light reflection, is described as a display device of one embodiment of the present invention with reference to FIGS. 2A to 2C. Note that as the display element, a transmissive or reflective liquid crystal element, a MEMS element, or the like can be used. As a driving mode, it is possible to employ a vertical alignment (VA) mode, specific examples of which are a multi-domain vertical alignment (MVA) mode, a patterned vertical alignment (PVA) mode, and the like. Furthermore, a twisted nematic (TN) mode, an in-plane-switching (IPS) mode, a fringe field switching (FFS) mode, an optically compensated birefringence (OCB) mode, a blue phase, or the like can be used.

A display device illustrated in FIG. 2A is an active matrix display device which includes a transistor (FET) 202 that is a driving element and a liquid crystal element 203 between a first substrate 200 and a second substrate 205 and in which the transistor (FET) 202 and the liquid crystal element 203 are electrically connected.

### <<Structure of Liquid Crystal Element>>

The liquid crystal element 203 described in this embodiment is a reflective liquid crystal element that includes a liquid crystal layer 204 between a first electrode 207 and a second electrode 208, and the first electrode 207 illustrated in FIG. 2A functions as a reflective electrode.

For the first electrode 207, a material that reflects visible light can be used. Specifically, a material containing silver can be used. For example, a material containing silver, palladium, and the like or a material containing silver, copper, and the like can be used. Furthermore, a material with unevenness on its surface can also be used. In that case, incident light can be reflected in various directions so that a white image can be displayed.

For the second electrode 208, a material that transmits visible light can be used. For example, a conductive oxide, a metal film thin enough to transmit light, or a metal nanowire can be used. Specifically, a conductive oxide containing indium, a metal thin film with a thickness of greater than or equal to 1 nm and less than or equal to 10 nm, or a metal nanowire containing silver can be used. Alternatively, indium oxide, indium tin oxide, indium zinc oxide, zinc oxide, zinc oxide to which gallium is added, zinc oxide to which aluminum is added, or the like can be used.

An alignment film 210 is provided between the first electrode 207 and the liquid crystal layer 204, and an alignment film 211 is provided between the second electrode 208 and the liquid crystal layer 204. A spacer 209 is provided to maintain the distance between the electrodes.

For the alignment films 210 and 211, a material containing polyimide or the like can be used. Specifically, a material formed to have alignment in a predetermined direction by rubbing treatment or an optical alignment technique can be used.

As the liquid crystal layer 204, a thermotropic liquid crystal, a low-molecular liquid crystal, a high-molecular liquid crystal, a polymer dispersed liquid crystal, a ferroelectric liquid crystal, an anti-ferroelectric liquid crystal, or the like can be used. A liquid crystal which exhibits a cholesteric phase, a smectic phase, a cubic phase, a chiral nematic phase, an isotropic phase, or the like can be used. A liquid crystal exhibiting a blue phase can also be used, for example.

An organic layer 201 is provided between the first substrate 200 and the second substrate 205 and formed using a dichroic dye and a liquid crystalline monomer (or a dichroic dye, a liquid crystal, and a monomer). Note that the organic layer 201 is provided to overlap with at least the liquid crystal element 203 and can be provided to overlap with the transistor (FET) 202 or a wiring as needed. The organic layer 201 functions as a polarizer and transmits only light in one direction and thus has a function of preventing reflection of external light when used in combination with a retardation layer 212. Embodiment 1 can be referred to for the details of the organic layer 201.

In the display device illustrated in FIG. 2A, the retardation layer 212 (or a retardation film) and a diffusion layer 216 (or a diffusion film) are provided between the organic layer 201 and the liquid crystal element 203. Owing to the retardation layer 212, light that is transmitted through the liquid crystal layer 204 can be extracted to the outside. Note that by adjusting the phase difference between the retardation layer 212 and the liquid crystal layer 204, the amount of transmitted light can be adjusted. The diffusion layer 216 can prevent light that is reflected by the first electrode 207 from being metallic white because of an electrode material when a white image is displayed. As illustrated in FIG. 2A, an insulating layer 217 may be provided between the organic layer 201 and the retardation layer 212 and an insulating layer 218 may be provided between the diffusion layer 216 and a color filter 213.

The color filter 213 is provided between the retardation layer 212 and the liquid crystal element 203. Note that the positions of the organic layer 201 and the color filter 213 may be interchanged. The color filter 213 is a filter that transmits visible light in a specific wavelength range and blocks visible light in a specific wavelength range. Thus, when the color filter 213 transmitting only light in a specific wavelength range is provided appropriately, an emission color of the liquid crystal element can be adjusted. Note that a black layer (black matrix) 214 may be provided at an end portion of the color filter 213. The surfaces of the color filter 213 and the black layer 214 may be covered with an overcoat layer 215 formed using a transparent material.

A terminal portion 220 is illustrated in FIG. 2A. The terminal portion 220 is electrically connected to a conductive layer obtained by processing the same conductive film as the first electrode 207. Thus, the terminal portion 220 and an FPC 221 can be electrically connected to each other through a connection layer 222.

Note that a region denoted as “231” in FIG. 2A and including the above-described liquid crystal element 203 corresponds to one pixel in a pixel portion of the display device.

### <<Structure of Display Device>>

Next, an example of a display device including the above-described structure in FIG. 2A is described with reference to FIG. 2B. The display device described here mainly includes a control portion 240 and a display portion 241. The control portion 240 controls a signal line driver circuit (hereinafter referred to as an S driver circuit 250) and a scan line driver circuit (hereinafter referred to as a G driver circuit 251). The display portion 241 includes a pixel portion 230, in which each pixel 231 includes a liquid crystal element 232, and driver circuits such as the S driver circuit 250 and the G driver circuit 251.

In the pixel portion 230 of the display portion 241, a plurality of pixels 231, a plurality of scanning lines G for selecting the pixels 231 row by row, and a plurality of signal lines S for supplying S signals to the pixels 231 that are selected are provided.

The input of G signals to the scan lines G is controlled by the G driver circuit 251. The input of the S signals to the signal lines S is controlled by the S driver circuit 250. Each of the plurality of pixels 231 is connected to at least one of the scan lines G and at least one of the signal lines S.

Note that the kind and number of wirings provided in the pixel portion 230 can be determined in accordance with the configuration, number, and arrangement of the pixels 231. Specifically, in the pixel portion 230 in FIG. 2B, the pixels 231 are arranged in a matrix of x columns and y rows, and signal lines S1 to Sx and scan lines G1 to Gy are arranged in the pixel portion 230.

### <Configuration of Pixel>

The pixel 231 illustrated FIG. 2B can have a configuration illustrated in FIG. 2C, for example. That is, the pixel includes the liquid crystal element 232, a transistor 233, a capacitor 234, and the like. Note that the transistor 233 controls supply of the S signals to the liquid crystal element 232. Specifically, a gate of the transistor 233 is connected to one of the scan lines G1 to Gy. One of a source and a drain of the transistor 233 is connected to one of the signal lines S1 to Sx. The other of the source and the drain of the transistor 233 is connected to a first electrode of the liquid crystal element 232.

As needed, the pixel may include, in addition to the capacitor 234 for holding the voltage between the first electrode and a second electrode of the liquid crystal element 232, another circuit element such as a transistor, a diode, a resistor, a capacitor, or an inductor.

In FIG. 2C, one transistor 233 is used as a switching element for controlling the input of the S signal to the pixel 231. Alternatively, a plurality of transistors functioning as one switching element may be included in the pixel 231. The plurality of transistors functioning as one switching element may be connected to each other in parallel, in series, or in combination of parallel connection and series connection.

The liquid crystal element 232 includes the first electrode, the second electrode, and a liquid crystal layer containing a liquid crystal material to which the voltage between the first electrode and the second electrode is applied. In the liquid crystal element 232, the alignment of liquid crystal molecules is changed in accordance with the voltage applied between the first electrode and the second electrode, so that the transmittance is changed. Thus, the transmittance of the liquid crystal element 232 is controlled, whereby gradation display can be performed.

The transistor 233 controls whether the potential of the signal line S is supplied to the first electrode of the liquid crystal element 232. A predetermined reference potential V_{com} is supplied to the second electrode of the liquid crystal element 232. Although any of various known transistors can be used as the transistor 233, a transistor including an oxide semiconductor can be suitably used.

Although not illustrated in FIG. 2B, the display portion 241 may include a light supply portion in which a plurality of light sources are provided. Driving of the light sources in the light supply portion is controlled by the control portion 240. Note that in the case where a reflective liquid crystal element is used as described in this embodiment, outdoor sunlight, light from indoor lighting, or the like can be used as a light source and a light supply portion is not necessarily provided. However, even when a transmissive liquid crystal element or a reflective liquid crystal element is used, if the use at nighttime or in a dark place with no light source or a dim light source is assumed, the light supply portion needs to be provided.

The structure described in this embodiment can be used in appropriate combination with the structure described in any of other embodiments.

### Embodiment 3

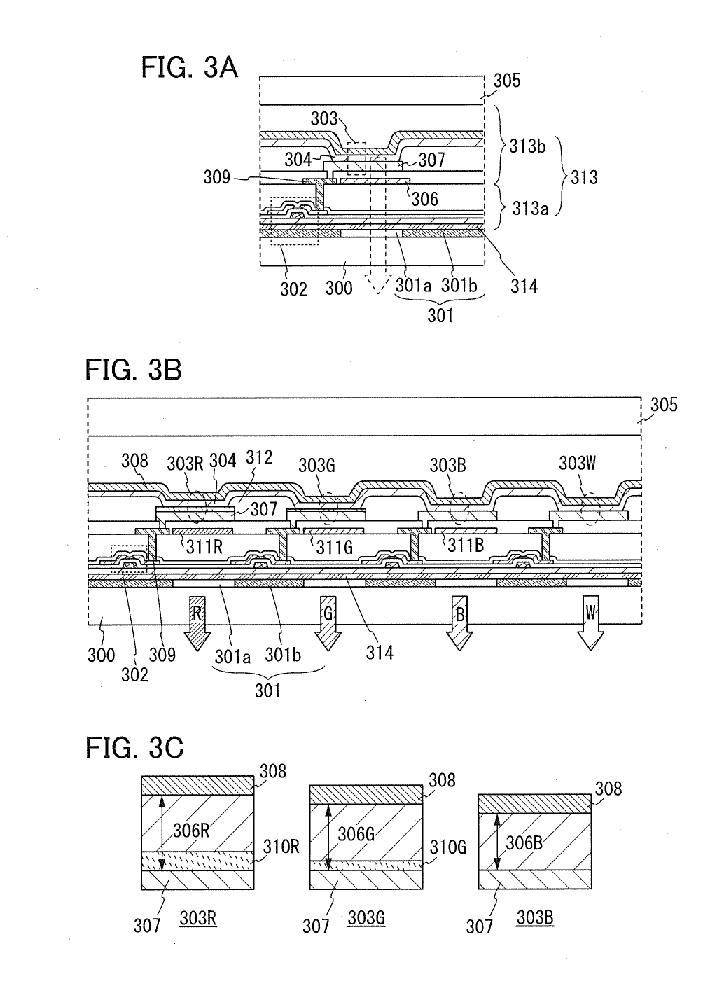

In this embodiment, an example of a display device including a light-emitting element in an element layer, which is a display device of one embodiment of the present invention, is described with reference to FIGS. 3A to 3C.

A display device in FIG. 3A is an active matrix display device which includes an element layer 313 between a first substrate 300 and a second substrate 305. The element layer 313 includes a driving element layer 313a including a transistor (FET) 302 that is a driving element and a display element layer 313b including a light-emitting element 303. A wiring 309 is provided to electrically connect the transistor (FET) 302 formed in the driving element layer 313a and the light-emitting element 303 formed in the display element layer 313b. An organic layer 301 is provided between the first substrate 300 and the element layer 313. Note that the organic layer 301 includes a first organic layer 301a that can transmit visible light and a second organic layer 301b that serves as a polarizer.

In a display device in FIG. 3B, the light-emitting element 303 formed in the display element layer 313b is a bottom emission light-emitting element that emits light to the first electrode 307 side. Light generated in an EL layer 304 of the light-emitting element 303 is emitted to the outside through a color filter (311R, 311G, or 311B) and the first organic layer 301a. The color filter (311R, 311G, or 311B) is provided between a light-emitting element (303R, 303G, 303B, or 303W) and the transistor (FET) 302. Therefore, the first electrode 307 and the first organic layer 301a each have a light-transmitting property with respect to visible light (specifically, the first electrode 307 has a visible light transmittance of greater than or equal to 40%). Since the light-emitting element described in this embodiment has a microcavity structure, the first electrode 307 is formed to serve as a semi-transmissive and semi-reflective electrode and the second electrode 308 is formed to serve as a reflective electrode.

The first organic layer 301a is positioned to overlap with the light-emitting element 303. The second organic layer 301b serves as a polarizer and is thus provided to overlap with the transistor 302 and the wiring 309, where external light might be reflected. When used in combination with a retardation layer 314, the second organic layer 301b can prevent the transistor 302 and the wiring 309 from reflecting external light.

The display device in FIG. 3B includes a plurality of light-emitting elements that include the common EL layer 304. The display device also includes color filters and microcavity structures in which the optical path lengths between electrodes of the light-emitting elements are adjusted in accordance with the emission colors of the light-emitting elements. Note that this structure is an example and one embodiment of the present invention is not limited to this structure; the light-emitting elements exhibiting different emission colors may have the respective EL layers that are separately formed using different materials. Furthermore, microcavity structures are not necessarily required and can be provided as needed.

An end portion of the first electrode 307 is covered with an insulator 312. The insulator 312 can be formed using an organic compound such as a negative photosensitive resin or a positive photosensitive resin (an acrylic resin), or an inorganic compound such as silicon oxide, silicon oxynitride, or silicon nitride. The insulator 312 preferably has a curved surface with curvature at an upper end portion or a lower end portion thereof. In this manner, favorable coverage with a film formed over the insulator 312 can be obtained.

The light-emitting elements (303R, 303G, 303B, and 303W) in FIG. 3B are bottom emission light-emitting elements, and many transistors 302 and many wirings 309 are provided on the first substrate 300 side. The transistors 302 and the wirings 309 cause reflection of external light. However, the organic layer 301 provided between the first substrate 300 and the transistor 302 has a function of preventing reflection of external light but does not inhibit emission of light from the light-emitting element; accordingly, reflection of external light can be inhibited without reducing the luminance of light emitted from the light-emitting elements (303R, 303G, 303B, and 303W). The structures, configurations, or combination of emission colors of the light-emitting elements are effective in not only the device described in this embodiment but also display devices that have various light-emitting element structures and are configured to prevent reflection of external light with the organic layer 301 provided between the first substrate 300 and the second substrate 305.

The plurality of light-emitting elements in FIG. 3B are the light-emitting element 303R that is a red-light-emitting element, the light-emitting element 303G that is a green-light-emitting element, the light-emitting element 303B that is a blue-light-emitting element, and the light-emitting element 303W that is a white-light-emitting element. FIG. 3C illustrates microcavity structures of these light-emitting elements. In other words, the gap between the first electrode 307 and the second electrode 308 in the light-emitting element 303R is adjusted to have an optical path length 306R; the gap between the first electrode 307 and the second electrode 308 in the light-emitting element 303G is adjusted to have an optical path length 306G; and the gap between the first electrode 307 and the second electrode 308 in the light-emitting element 303B is adjusted to have an optical path length 306B. As illustrated in FIG. 3C, optical adjustment is performed in such a manner that the conductive layer 310R is stacked over the first electrode 307 in the light-emitting element 303R and the conductive layer 310G is stacked over the first electrode 307 in the light-emitting element 303G.

Although the color filters (311R, 311G, and 311B) are provided between the transistors 302 and the light-emitting elements (303R, 303G, 303B, and 303W) as shown in FIG. 3B, the color filters may be provided at any position as long as light from the light-emitting elements is emitted to the outside through the color filters and the light-emitting elements overlap with the color filters. The color filter is a filter that transmits visible light in a specific wavelength range and blocks visible light in a specific wavelength range. Thus, as illustrated in FIG. 3B, the color filter 311R that transmits only light in the red wavelength range is provided in a position overlapping with the light-emitting element 303R, whereby red light emission can be obtained from the light-emitting element 303R. Furthermore, the color filter 311G that transmits only light in the green wavelength range is provided in a position overlapping with the light-emitting element 303G, whereby green light emission can be obtained from the light-emitting element 303G. Furthermore, the color filter 311B that transmits only light in the blue wavelength range is provided in a position overlapping with the light-emitting element 303B, whereby blue light emission can be obtained from the light-emitting element 303B. Note that the light-emitting element 303W can provide white light emission without a color filter although a color filter may be provided as needed. Note that a black layer (black matrix) may be provided at an end portion of the color filter.

In FIG. 3B, the light-emitting elements are the red-light-emitting element, the green-light-emitting element, the blue-light-emitting element, and the white-light-emitting element; however, the light-emitting elements included in the display device of one embodiment of the present invention are not limited to the above, and a yellow-light-emitting element or an orange-light-emitting element may be provided.

### <<Structure of Light-Emitting Element>>

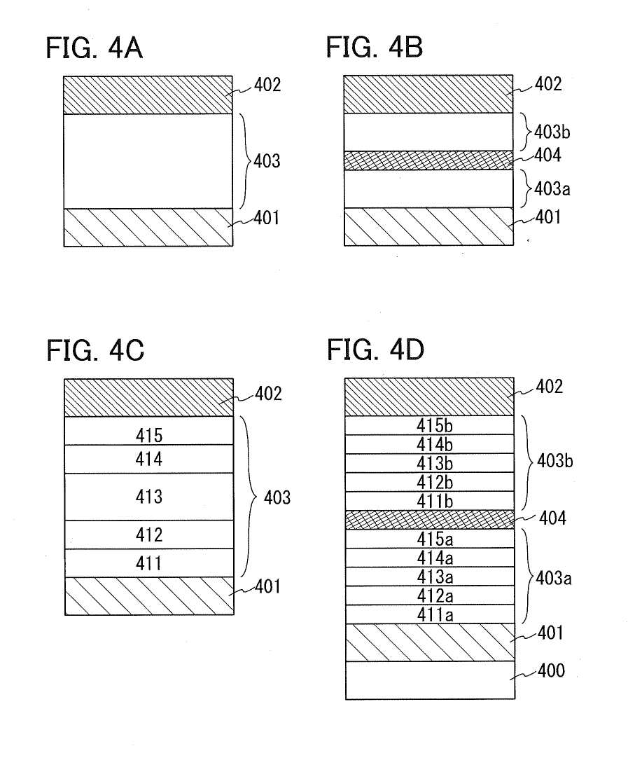

Next, a basic structure of the light-emitting element included in the display device in this embodiment is described. FIG. 4A illustrates a light-emitting element in which an EL layer including a light-emitting layer is provided between a pair of electrodes. Specifically, an EL layer 403 is provided between a first electrode 401 and a second electrode 402.

FIG. 4B illustrates a light-emitting element that has a stacked-layer structure (tandem structure) in which a plurality of EL layers (two EL layers 403a and 403b in FIG. 4B) are provided between a pair of electrodes and a charge generation layer 404 is provided between the EL layers. With the use of such a tandem light-emitting element, a low-power display device which can be driven at low voltage can be obtained.

The charge generation layer 404 has a function of injecting electrons into one of the EL layers (403a or 403b) and injecting holes into the other of the EL layers (403b or 403a) when a voltage is applied between the first electrode 401 and the second electrode 402. Thus, in FIG. 4B, when a voltage is applied between the first electrode 401 and the second electrode 402 such that the potential of the first electrode 401 is higher than that of the second electrode 402, the charge generation layer 404 injects electrons into the EL layer 403a and injects holes into the EL layer 403b.

Note that in terms of light extraction efficiency, the charge generation layer 404 preferably has a light-transmitting property with respect to visible light (specifically, the charge generation layer 404 has a visible light transmittance of 40% or more). The charge generation layer 404 functions even if it has lower conductivity than the first electrode 401 or the second electrode 402.

FIG. 4C illustrates an example in which the EL layer 403 of the light-emitting element in FIG. 4A has a stacked-layer structure. Note that in that case, it is assumed that the first electrode 401 functions as an anode and the second electrode 402 functions as a cathode. The EL layer 403 has a structure in which a hole-injection layer 411, a hole-transport layer 412, a light-emitting layer 413, an electron-transport layer 414, and an electron-injection layer 415 are stacked in this order over the first electrode 401. Also in the case where a plurality of EL layers are provided as in the tandem structure illustrated in FIG. 4B, the layers in each EL layer are sequentially stacked from the anode side as described above. When the first electrode 401 is a cathode and the second electrode 402 is an anode, the stacking order of the layers is reversed.

The light-emitting layer 413 included in the EL layer 403 in FIG. 4C contains an appropriate combination of a light-emitting substance and a plurality of substances, so that fluorescence or phosphorescence of a desired emission color can be obtained. The light-emitting layer 413 may include stacked layers having different emission colors. In that case, the light-emitting substance and other substances are different between the stacked light-emitting layers. Alternatively, the light-emitting layers in the plurality of EL layers (403a and 403b) in FIG. 4B may exhibit the respective emission colors. Also in that case, the light-emitting substance and other substances are different between the light-emitting layers.

In the above-described light-emitting element, for example, a micro optical resonator (microcavity) structure is employed in which the first electrode 401 is a semi-transmissive and semi-reflective electrode and the second electrode 402 is a reflective electrode as shown in FIG. 4C, whereby light emission from the light-emitting layer 413 in the EL layer 403 can be resonated between the electrodes so that light emission reflected from the second electrode 402 can be intensified.

Note that when the first electrode 401 of the light-emitting element is a reflective electrode with a structure in which a reflective conductive material and a light-transmitting conductive material (a transparent conductive film) are stacked, optical adjustment can be performed by controlling the thickness of the transparent conductive film. Specifically, when the wavelength of light from the light-emitting layer 413 is λ, the distance between the first electrode 401 and the second electrode 402 is preferably adjusted to around mλ/2 (m is a natural number).

To amplify desired light (wavelength: λ) obtained from the light-emitting layer 413, the optical path length from the first electrode 401 to a region in the light-emitting layer 413 emitting the desired light (light-emitting region) and the optical path length from the second electrode 402 to the region in the light-emitting layer 413 emitting the desired light (light-emitting region) are preferably adjusted to around (2m′+1)λ/4 (m′ is a natural number). Here, the light-emitting region means a region where holes and electrons are recombined in the light-emitting layer 413.

By such optical adjustment, the spectrum of specific monochromatic light from the light-emitting layer 413 can be narrowed and light emission with a high color purity can be obtained.

In that case, the optical path length between the first electrode 401 and the second electrode 402 is, to be exact, represented by the total thickness from a reflective region in the first electrode 401 to a reflective region in the second electrode 402. However, it is difficult to exactly determine the reflective regions in the first electrode 401 and the second electrode 402; thus, it is assumed that the above effect can be sufficiently obtained wherever the reflective regions may be set in the first electrode 401 and the second electrode 402. Further, the optical path length between the first electrode 401 and the light-emitting layer emitting desired light is, to be exact, the optical path length between the reflective region in the first electrode 401 and the light-emitting region in the light-emitting layer emitting desired light. However, it is difficult to exactly determine the reflective region in the first electrode 401 and the light-emitting region in the light-emitting layer emitting desired light; thus, it is assumed that the above effect can be sufficiently obtained wherever the reflective region and the light-emitting region may be set in the first electrode 401 and the light-emitting layer emitting desired light.

When microcavity structures are employed, light (monochromatic light) with wavelengths that differ between the light-emitting elements can be extracted even when the light-emitting elements include the same EL layer; thus, the microcavity structures are advantageous in achieving high resolution. In the case where microcavity structures are employed and EL layers are separately formed for the light-emitting elements (e.g., R, G, and B), the color purity of an emission color can be increased and thus, coloring layers (color filters) are not needed, in which case power consumption can be reduced.

In the light-emitting element described in this embodiment, at least one of the first electrode 401 and the second electrode 402 is a light-transmitting electrode (a transparent electrode, a semi-transmissive and semi-reflective electrode, or the like). In the case where the light-transmitting electrode is a transparent electrode, the transparent electrode has a visible light transmittance of greater than or equal to 40%. In the case where the light-transmitting electrode is a semi-transmissive and semi-reflective electrode, the semi-transmissive and semi-reflective electrode has a visible light reflectance of greater than or equal to 20% and less than or equal to 80%, preferably greater than or equal to 40% and less than or equal to 70%. These electrodes preferably have a resistivity of 1×10⁻² Ωcm or less.

Furthermore, when one of the first electrode 401 and the second electrode 402 is a reflective electrode in the above light-emitting element, the visible light reflectance of the reflective electrode is greater than or equal to 40% and less than or equal to 100%, preferably greater than or equal to 70% and less than or equal to 100%. This electrode preferably has a resistivity of 1×10⁻² Ωcm or less.

### <<Specific Structure and Manufacturing Method of Light-Emitting Element>>

A specific structure and a specific manufacturing method of the light-emitting element used in the display device in this embodiment are described below. Here, a bottom emission light-emitting element having the tandem structure in FIG. 4B and microcavity structures is described with reference to FIG. 4D. In the light-emitting element in FIG. 4D, a semi-transmissive and semi-reflective electrode is formed as the first electrode 401 and a reflective electrode is formed as the second electrode 402. Therefore, a single-layer structure or a stacked-layer structure can be formed using one or more kinds of desired electrode materials. Note that the second electrode 402 is formed after formation of the EL layer 403b, with the use of a material selected as described above. For fabrication of these electrodes, a sputtering method or a vacuum evaporation method can be used.

### <First Electrode and Second Electrode>

As materials for forming the first electrode 401 and the second electrode 402, any of the materials below can be used in an appropriate combination as long as the functions of the electrodes described above can be fulfilled. For example, a metal, an alloy, an electrically conductive compound, a mixture of these, and the like can be appropriately used. Specifically, an In—Sn oxide (also referred to as ITO), an In—Si—Sn oxide (also referred to as ITSO), an In—Zn oxide, an In—W—Zn oxide, or the like can be used. In addition, it is possible to use a metal such as aluminum (Al), titanium (Ti), chromium (Cr), manganese (Mn), iron (Fe), cobalt (Co), nickel (Ni), copper (Cu), gallium (Ga), zinc (Zn), indium (In), tin (Sn), molybdenum (Mo), tantalum (Ta), tungsten (W), palladium (Pd), gold (Au), platinum (Pt), silver (Ag), yttrium (Y), or neodymium (Nd) or an alloy containing an appropriate combination of any of these metals. It is also possible to use a Group 1 element or a Group 2 element in the periodic table (e.g., lithium (Li), cesium (Cs), calcium (Ca), or strontium (Sr)), a rare earth metal such as europium (Eu) or ytterbium (Yb), an alloy containing an appropriate combination of any of these elements, graphene, or the like.

In the light-emitting element in FIG. 4D, when the first electrode 401 is an anode, a hole-injection layer 411a and a hole-transport layer 412a of the EL layer 403a are sequentially stacked over the first electrode 401 by a vacuum evaporation method. After formation of the EL layer 403a and the charge generation layer 404, a hole-injection layer 411b and a hole-transport layer 412b of the EL layer 403b are sequentially stacked over the charge generation layer 404 in a similar manner.

### <Hole-Injection Layer and Hole-Transport Layer>

The hole-injection layers (411a and 411b) inject holes from the first electrode 401 that is an anode to the EL layers (403a and 403b) and each contain a material with a high hole-injection property.

As examples of the material with a high hole-injection property, transition metals oxides such as molybdenum oxide, vanadium oxide, ruthenium oxide, tungsten oxide, and manganese oxide can be given. Alternatively, it is possible to use any of the following materials: phthalocyanine-based compounds such as phthalocyanine (abbreviation: H₂Pc) and copper phthalocyanine (abbreviation: CuPc); aromatic amine compounds such as 4,4′-bis[N-(4-diphenylaminophenyl)-N-phenylamino]biphenyl (abbreviation: DPAB) and N,N′-bis{4-[bis(3-methylphenyl)amino]phenyl}-N,N′-diphenyl-(1,1′-biphenyl)-4,4′-diamine (abbreviation: DNTPD); high molecular compounds such as poly(3,4-ethylenedioxythiophene)/poly(styrenesulfonic acid) (abbreviation: PEDOT/PSS); and the like.

Alternatively, as the material with a high hole-injection property, a composite material containing a hole-transport material and an acceptor material (an electron-accepting material) can also be used. In that case, the acceptor material extracts electrons from a hole-transport material, so that holes are generated in the hole-injection layer 411, and the holes are injected into the light-emitting layers (413a and 413b) through the hole-transport layers (412a and 412b). Note that each of the hole-injection layers (411a and 411b) may be formed to have a single-layer structure using a composite material containing a hole-transport material and an acceptor material (an electron-accepting material), or a stacked-layer structure in which a layer including a hole-transport material and a layer including an acceptor material (an electron-accepting material) are stacked.

The hole-transport layers (412a and 412b) transport the holes, which are injected from the first electrode 401 by the hole-injection layers (411a and 411b), to the light-emitting layers (413a and 413b). Note that the hole-transport layers (412a and 412b) each contain a hole-transport material. It is particularly preferable that the HOMO level of the hole-transport material included in the hole-transport layers (412a and 412b) be the same as or close to that of the hole-injection layers (411a and 411b).

Examples of the acceptor material used for the hole-injection layers (411a and 411b) include an oxide of a metal belonging to any of Group 4 to Group 8 of the periodic table. Specifically, molybdenum oxide, vanadium oxide, niobium oxide, tantalum oxide, chromium oxide, tungsten oxide, manganese oxide, and rhenium oxide can be given. Among these, molybdenum oxide is especially preferable since it is stable in the air, has a low hygroscopic property, and is easy to handle. Alternatively, organic acceptors such as a quinodimethane derivative, a chloranil derivative, and a hexaazatriphenylene derivative can be used. Specifically, 7,7,8,8-tetracyano-2,3,5,6-tetrafluoroquinodimethane (abbreviation: F₄-TCNQ), chloranil, 2,3,6,7,10,11-hexacyano-1,4,5,8,9,12-hexaazatriphenylene (abbreviation: HAT-CN), or the like can be used.

The hole-transport materials used for the hole-injection layers (411a and 411b) and the hole-transport layers (412a and 412b) are preferably substances with a hole mobility of greater than or equal to 10⁻⁶ cm²/Vs. Note that other substances may be used as long as the substances have a hole-transport property higher than an electron-transport property.

Preferred hole-transport materials are π-electron rich heteroaromatic compounds (e.g., carbazole derivatives and indole derivatives) and aromatic amine compounds, examples of which include compounds having an aromatic amine skeleton, such as 4,4′-bis[N-(1-naphthyl)-N-phenylamino]biphenyl (abbreviation: NPB or α-NPD), N,N′-bis(3-methylphenyl)-N,N′-diphenyl-[1,1′-biphenyl]-4,4′-diamine (abbreviation: TPD), 4,4′-bis[N-(spiro-9,9′-bifluoren-2-yl)-N-phenylamino]biphenyl (abbreviation: BSPB), 4-phenyl-4′-(9-phenylfluoren-9-yl)triphenylamine (abbreviation: BPAFLP), 4-phenyl-3′-(9-phenylfluoren-9-yl)triphenylamine (abbreviation: mBPAFLP), 4-phenyl-4′-(9-phenyl-9H-carbazol-3-yl)triphenylamine (abbreviation: PCBA1BP), 3-[4-(9-phenanthryl)-phenyl]-9-phenyl-9H-carbazole (abbreviation: PCPPn), N-(4-biphenyl)-N-(9,9-dimethyl-9H-fluoren-2-yl)-9-phenyl-9H-carbazol-3-amine (abbreviation: PCBiF), N-(1,1′-biphenyl-4-yl)-N-[4-(9-phenyl-9H-carbazol-3-yl)phenyl]-9,9-dimethyl-9H-fluoren-2-amine (abbreviation: PCBBiF), 4,4′-diphenyl-4″-(9-phenyl-9H-carbazol-3-yl)triphenylamine (abbreviation: PCBBi1BP), 4-(1-naphthyl)-4′-(9-phenyl-9H-carbazol-3-yl)triphenylamine (abbreviation: PCBANB), 4,4′-di(1-naphthyl)-4″-(9-phenyl-9H-carbazol-3-yl)triphenylamine (abbreviation: PCBNBB), 9,9-dimethyl-N-phenyl-N-[4-(9-phenyl-9H-carbazol-3-yl)phenyl]fluoren-2-amine (abbreviation: PCBAF), N-phenyl-N-[4-(9-phenyl-9H-carbazol-3-yl)phenyl]spiro-9,9′-bifluoren-2-amine (abbreviation: PCBASF), 4,4′,4″-tris(carbazol-9-yl)triphenylamine (abbreviation: TCTA), 4,4′,4″-tris(N,N-diphenylamino)triphenylamine (abbreviation: TDATA), 4,4′,4″-tris[N-(3-methylphenyl)-N-phenylamino]triphenylamine (abbreviation: MTDATA), and 4,4′-bis[N-(spiro-9,9′-bifluoren-2-yl)-N-phenylamino]biphenyl (abbreviation: BSPB); compounds having a carbazole skeleton, such as 1,3-bis(N-carbazolyl)benzene (abbreviation: mCP), 4,4′-di(N-carbazolyl)biphenyl (abbreviation: CBP), 3,6-bis(3,5-diphenylphenyl)-9-phenylcarbazole (abbreviation: CzTP), 3,3′-bis(9-phenyl-9H-carbazole) (abbreviation: PCCP), 3-[N-(9-phenylcarbazol-3-yl)-N-phenylamino]-9-phenylcarbazole (abbreviation: PCzPCA1), 3,6-bis[N-(9-phenylcarbazol-3-yl)-N-phenylamino]-9-phenylcarbazole (abbreviation: PCzPCA2), 3-[N-(1-naphthyl)-N-(9-phenylcarbazol-3-yl)amino]-9-phenylcarbazole (abbreviation: PCzPCN1), 1,3,5-tris[4-(N-carbazolyl)phenyl]benzene (abbreviation: TCPB), and 9-[4-(10-phenyl-9-anthracenyl)phenyl]-9H-carbazole (abbreviation: CzPA); compounds having a thiophene skeleton, such as 4,4′,4″-(benzene-1,3,5-triyl)tri(dibenzothiophene) (abbreviation: DBT3P-II), 2,8-diphenyl-4-[4-(9-phenyl-9H-fluoren-9-yl)phenyl]dibenzothiophene (abbreviation: DBTFLP-III), and 4-[4-(9-phenyl-9H-fluoren-9-yl)phenyl]-6-phenyldibenzothiophene (abbreviation: DBTFLP-IV); and compounds having a furan skeleton, such as 4,4′,4″-(benzene-1,3,5-triyl)tri(dibenzofuran) (abbreviation: DBF3P-II) and 4-{3-[3-(9-phenyl-9H-fluoren-9-yl)phenyl]phenyl}dibenzofuran (abbreviation: mmDBFFLBi-II).

A high molecular compound such as poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacrylamide] (abbreviation: PTPDMA), or poly[N,N′-bis(4-butylphenyl)-N,N′-bis(phenyl)benzidine] (abbreviation: Poly-TPD) can also be used.

Note that the hole-transport material is not limited to the above examples and may be one of or a combination of various known materials when used for the hole-injection layers (411a and 411b) and the hole-transport layers (412a and 412b).

Next, in the light-emitting element in FIG. 4D, the light-emitting layer 413a is formed over the hole-transport layer 412a of the EL layer 403a by a vacuum evaporation method. After the EL layer 403a and the charge generation layer 404 are formed, the light-emitting layer 413b is formed over the hole-transport layer 412b of the EL layer 403b by a vacuum evaporation method.

### <Light-Emitting Layer>

The light-emitting layers (413a and 413b) each contain a light-emitting substance. Note that as the light-emitting substance, a substance whose emission color is blue, violet, bluish violet, green, yellowish green, yellow, orange, red, or the like is appropriately used. When the plurality of light-emitting layers (413a and 413b) are formed using different light-emitting substances, different emission colors can be exhibited (for example, complementary emission colors are combined to achieve white light emission). Furthermore, a stacked-layer structure in which one light-emitting layer contains two or more kinds of light-emitting substances may be employed.

The light-emitting layers (413a and 413b) may contain one or more kinds of organic compounds (a host material and an assist material) in addition to a light-emitting substance (a guest material). As the one or more kinds of organic compounds, one or both of the hole-transport material and the electron-transport material described in this embodiment can be used.

In a structure example of the light-emitting element shown in FIG. 4D, a light-emitting substance exhibiting blue light emission (a blue-light-emitting substance) is used as a guest material in one of the light-emitting layers (413a and 413b) and a substance exhibiting green light emission (a green-light-emitting substance) and a substance exhibiting red light emission (a red-light-emitting substance) are used in the other light-emitting layer. Such a combination is effective in the case where the blue-light-emitting substance (the blue-light-emitting layer) has a lower emission efficiency or a shorter lifetime than the substances (layers) exhibiting other colors. A light-emitting substance that converts singlet excitation energy into light emission in the visible light range is used as the blue-light-emitting substance and light-emitting substances that convert triplet excitation energy into light emission in the visible light range are used as the green- and red-light-emitting substances, whereby the spectrum balance between R, G, and B is improved.

There is no particular limitation on the light-emitting substances that can be used for the light-emitting layers (413a and 413b), and a light-emitting substance that converts singlet excitation energy into light emission in the visible light range or a light-emitting substance that converts triplet excitation energy into light emission in the visible light range can be used. Examples of the light-emitting substance are given below.

As an example of the light-emitting substance that converts singlet excitation energy into light emission, a substance emitting fluorescence (a fluorescent material) can be given. Examples of the substance emitting fluorescence include a pyrene derivative, an anthracene derivative, a triphenylene derivative, a fluorene derivative, a carbazole derivative, a dibenzothiophene derivative, a dibenzofuran derivative, a dibenzoquinoxaline derivative, a quinoxaline derivative, a pyridine derivative, a pyrimidine derivative, a phenanthrene derivative, and a naphthalene derivative. A pyrene derivative is particularly preferable because it has a high emission quantum yield. Specific examples of the pyrene derivative include N,N′-bis(3-methylphenyl)-N,N′-bis[3-(9-phenyl-9H-fluoren-9-yl)phenyl]pyrene-1,6-diamine (abbreviation: 1,6mMemFLPAPrn), N,N′-diphenyl-N,N′-bis[4-(9-phenyl-9H-fluoren-9-yl)phenyl]pyrene-1,6-diamine (abbreviation: 1,6FLPAPrn), N,N′-bis(dibenzofuran-2-yl)-N,N′-diphenylpyrene-1,6-diamine (abbreviation: 1,6FrAPm), N,N′-bis(dibenzothiophen-2-yl)-N,N′-diphenylpyrene-1,6-diamine (abbreviation: 1,6ThAPrn), N,N′-(pyrene-1,6-diyl)bis[(N-phenylbenzo[b]naphtho[1,2-d]furan)-6-amine] (abbreviation: 1,6BnfAPrn), N,N′-(pyrene-1,6-diyl)bis[(N-phenylbenzo[b]naphtho[1,2-d]furan)-8-amine] (abbreviation: 1,6BnfAPrn-02), and N,N′-(pyrene-1,6-diyl)bis[(6,N-diphenylbenzo[b]naphtho[1,2-d]furan)-8-amine] (abbreviation: 1,6BnfAPrn-03).

In addition, it is possible to use 5,6-bis[4-(10-phenyl-9-anthryl)phenyl]-2,2′-bipyridine (abbreviation: PAP2BPy), 5,6-bis[4′-(10-phenyl-9-anthryl)biphenyl-4-yl]-2,2′-bipyridine (abbreviation: PAPP2BPy), N,N′-bis[4-(9H-carbazol-9-yl)phenyl]-N,N′-diphenylstilbene-4,4′-diamine (abbreviation: YGA2S), 4-(9H-carbazol-9-yl)-4′-(10-phenyl-9-anthryl)triphenylamine (abbreviation: YGAPA), 4-(9H-carbazol-9-yl)-4′-(9,10-diphenyl-2-anthryl)triphenylamine (abbreviation: 2YGAPPA), N,9-diphenyl-N-[4-(10-phenyl-9-anthryl)phenyl]-9H-carbazol-3-amine (abbreviation: PCAPA), 4-(10-phenyl-9-anthryl)-4′-(9-phenyl-9H-carbazol-3-yl)triphenylamine (abbreviation: PCBAPA), 4-[4-(10-phenyl-9-anthryl)phenyl]-4′-(9-phenyl-9H-carbazol-3-yl)triphenylamine (abbreviation: PCBAPBA), perylene, 2,5,8,11-tetra(tert-butyl)perylene (abbreviation: TBP), N,N″-(2-tert-butylanthracene-9,10-diyldi-4,1-phenylene)bis[N,N′,N′-triphenyl-1,4-phenylenediamine] (abbreviation: DPABPA), N,9-diphenyl-N-[4-(9,10-diphenyl-2-anthryl)phenyl]-9H-carbazol-3-amine (abbreviation: 2PCAPPA), N-[4-(9,10-diphenyl-2-anthryl)phenyl]-N,N′,N-triphenyl-1,4-phenylenediamine (abbreviation: 2DPAPPA), or the like.

As examples of a light-emitting substance that converts triplet excitation energy into light emission, a substance emitting phosphorescence (a phosphorescent material) and a thermally activated delayed fluorescence (TADF) material that exhibits thermally activated delayed fluorescence can be given.

Examples of a phosphorescent material include an organometallic complex, a metal complex (a platinum complex), and a rare earth metal complex. These substances exhibit the respective emission colors (emission peaks) and thus, any of them is appropriately selected according to need.

As examples of a phosphorescent material which exhibits blue or green light emission and whose emission spectrum has a peak wavelength of greater than or equal to 450 nm and less than or equal to 570 nm, the following substances can be given.

For example, organometallic complexes having a 4H-triazole skeleton, such as tris{2-[5-(2-methylphenyl)-4-(2,6-dimethylphenyl)-4H-1,2,4-triazol-3-yl-κN2]phenyl-κC}iridium(III) (abbreviation: [Ir(mpptz-dmp)₃]), tris(5-methyl-3,4-diphenyl-4H-1,2,4-triazolato)iridium(III) (abbreviation: [Ir(Mptz)₃]), tris[4-(3-biphenyl)-5-isopropyl-3-phenyl-4H-1,2,4-triazolato]iridium(III) (abbreviation: [Ir(iPrptz-3b)₃]), and tris[3-(5-biphenyl)-5-isopropyl-4-phenyl-4H-1,2,4-triazolato]iridium(III) (abbreviation: [Ir(iPr5btz)₃]); organometallic complexes having a 1H-triazole skeleton, such as tris[3-methyl-1-(2-methylphenyl)-5-phenyl-1H-1,2,4-triazolato]iridium(III) (abbreviation: [Ir(Mptz1-mp)₃]) and tris(1-methyl-5-phenyl-3-propyl-1H-1,2,4-triazolato)iridium(III) (abbreviation: [Ir(Prptz1-Me)₃]); organometallic complexes having an imidazole skeleton, such as fac-tris[1-(2,6-diisopropylphenyl)-2-phenyl-1H-imidazole]iridium(III) (abbreviation: [Ir(iPrpmi)₃]) and tris[3-(2,6-dimethylphenyl)-7-methylimidazo[1,2-f]phenanthridinato]iridium(III) (abbreviation: [Ir(dmpimpt-Me)₃]); organometallic complexes in which a phenylpyridine derivative having an electron-withdrawing group is a ligand, such as bis[2-(4′,6′-difluorophenyl)pyridinato-N,C^{2′}]iridium(III) tetrakis(1-pyrazolyl)borate (abbreviation: FIr6), bis[2-(4′,6′-difluorophenyl)pyridinato-N,C^{2′}]iridium(III) picolinate (abbreviation: FIrpic), bis{2-[3′,5′-bis(trifluoromethyl)phenyl]pyridinato-N,C^{2′}}iridium(III)picolinate (abbreviation: [Ir(CF₃ppy)₂(pic)]), bis[2-(4′,6′-difluorophenyl)pyridinato-N,C^{2′}]iridium(III) acetylacetonate (abbreviation: FIr(acac)); and the like can be given.

As examples of a phosphorescent material which exhibits green or yellow light emission and whose emission spectrum has a peak wavelength of greater than or equal to 495 nm and less than or equal to 590 nm, the following substances can be given.

For example, organometallic iridium complexes having a pyrimidine skeleton, such as tris(4-methyl-6-phenylpyrimidinato)iridium(III) (abbreviation: [Ir(mppm)₃]), tris(4-t-butyl-6-phenylpyrimidinato)iridium(III) (abbreviation: [Ir(tBuppm)₃]), (acetylacetonato)bis(6-methyl-4-phenylpyrimidinato)iridium(III) (abbreviation: [Ir(mppm)₂(acac)]), (acetylacetonato)bis(6-tert-butyl-4-phenylpyrimidinato)iridium(III) (abbreviation: [Ir(tBuppm)₂(acac)]), (acetylacetonato)bis[6-(2-norbornyl)-4-phenylpyrimidinato]iridium(III) (abbreviation: [Ir(nbppm)₂(acac)]), (acetylacetonato)bis[5-methyl-6-(2-methylphenyl)-4-phenylpyrimidinato]iridium(III) (abbreviation: [Ir(mpmppm)₂(acac)]), (acetylacetonato)bis{4,6-dimethyl-2-[6-(2,6-dimethylphenyl)-4-pyrimidinyl-κN3]phenyl-κC}iridium(III) (abbreviation: [Ir(dmppm-dmp)₂(acac)]), and (acetylacetonato)bis(4,6-diphenylpyrimidinato)iridium(III) (abbreviation: [Ir(dppm)₂(acac)]); organometallic iridium complexes having a pyrazine skeleton, such as (acetylacetonato)bis(3,5-dimethyl-2-phenylpyrazinato)iridium(III) (abbreviation: [Ir(mppr-Me)₂(acac)]) and (acetylacetonato)bis(5-isopropyl-3-methyl-2-phenylpyrazinato)iridium(III) (abbreviation: [Ir(mppr-iPr)₂(acac)]); organometallic iridium complexes having a pyridine skeleton, such as tris(2-phenylpyridinato-N,C^{2′})iridium(III) (abbreviation: [Ir(ppy)₃]), bis(2-phenylpyridinato-N,C^{2′})iridium(III) acetylacetonate (abbreviation: [Ir(ppy)₂(acac)]), bis(benzo[h]quinolinato)iridium(III) acetylacetonate (abbreviation: [Ir(bzq)₂(acac)]), tris(benzo[h]quinolinato)iridium(III) (abbreviation: [Ir(bzq)₃]), tris(2-phenylquinolinato-N,C^{2′})iridium(III) (abbreviation: [Ir(pq)₃]), and bis(2-phenylquinolinato-N,C^{2′})iridium(II) acetylacetonate (abbreviation: [Ir(pq)₂(acac)]); organometallic complexes such as bis(2,4-diphenyl-1,3-oxazolato-N,C^{2′})iridium(III) acetylacetonate (abbreviation: [Ir(dpo)₂(acac)]), bis{2-[4′-(perfluorophenyl)phenyl]pyridinato-N,C^{2′}}iridium(III) acetylacetonate (abbreviation: [Ir(p-PF-ph)₂(acac)]), and bis(2-phenylbenzothiazolato-N,C^{2′})iridium(III) acetylacetonate (abbreviation: [Ir(bt)₂(acac)]); and rare earth metal complexes such as tris(acetylacetonato)(monophenanthroline)terbium(III) (abbreviation: [Tb(acac)₃(Phen)]) can be given.

As examples of a phosphorescent material which exhibits yellow or red light emission and whose emission spectrum has a peak wavelength of greater than or equal to 570 nm and less than or equal to 750 nm, the following substances can be given.

For example, organometallic complexes having a pyrimidine skeleton, such as (diisobutyrylmethanato)bis[4,6-bis(3-methylphenyl)pyrimidinato]iridium(III) (abbreviation: [Ir(5mdppm)₂(dibm)]), bis[4,6-bis(3-methylphenyl)pyrimidinato](dipivaloylmethanato)iridium(III) (abbreviation: [Ir(5mdppm)₂(dpm)]), and bis[4,6-di(naphthalen-1-yl)pyrimidinato](dipivaloylmethanato)iridium(III) (abbreviation: [Ir(d1npm)₂(dpm)]); organometallic complexes having a pyrazine skeleton, such as (acetylacetonato)bis(2,3,5-triphenylpyrazinato)iridium(III) (abbreviation: [Ir(tppr)₂(acac)]), bis(2,3,5-triphenylpyrazinato)(dipivaloylmethanato)iridium(III) (abbreviation: [Ir(tppr)₂(dpm)]), bis{4,6-dimethyl-2-[3-(3,5-dimethylphenyl)-5-phenyl-2-pyrazinyl-κN]phenyl-κC}(2,6-dimethyl-3,5-heptanedionato-κ²O,O′)iridium(III) (abbreviation: [Ir(dmdppr-P)₂(dibm)]), bis{4,6-dimethyl-2-[5-(4-cyano-2,6-dimethylphenyl)-3-(3,5-dimethylphenyl)-2-pyrazinyl-κN]phenyl-κC}(2,2,6,6-tetramethyl-3,5-heptanedionato-κ²O,O′)iridium(III) (abbreviation: [Ir(dmdppr-dmCP)₂(dpm)]), (acetylacetonato)bis[2-methyl-3-phenylquinoxalinato-N,C^{2′}]iridium(III) (abbreviation: [Ir(mpq)₂(acac)]), (acetylacetonato)bis(2,3-diphenylquinoxalinato-N,C^{2′})iridium(III) (abbreviation: [Ir(dpq)₂(acac)]), and (acetylacetonato)bis[2,3-bis(4-fluorophenyl)quinoxalinato]iridium(III) (abbreviation: [Ir(Fdpq)₂(acac)]); organometallic complexes having a pyridine skeleton, such as tris(1-phenylisoquinolinato-N,C^{2′})iridium(III) (abbreviation: [Ir(piq)₃]) and bis(1-phenylisoquinolinato-N,C^{2′})iridium(III) acetylacetonate (abbreviation: [Ir(piq)₂(acac)]); platinum complexes such as 2,3,7,8,12,13,17,18-octaethyl-21H,23H-porphyrinplatinum(II) (abbreviation: [PtOEP]); and rare earth metal complexes such as tris(1,3-diphenyl-1,3-propanedionato)(monophenanthroline)europium(III) (abbreviation: [Eu(DBM)₃(Phen)]) and tris[1-(2-thenoyl)-3,3,3-trifluoroacetonato](monophenanthroline)europium(III) (abbreviation: [Eu(TTA)₃(Phen)]) can be given.

As the organic compounds (the host material and the assist material) used in the light-emitting layers (413a and 413b), one or more kinds of substances having a larger energy gap than the light-emitting substance (the guest material) are used.

When the light-emitting substance is a fluorescent material, it is preferable to use an organic compound that has a high energy level in a singlet excited state and has a low energy level in a triplet excited state. For example, an anthracene derivative or a tetracene derivative is preferably used. Specific examples include 9-phenyl-3-[4-(10-phenyl-9-anthryl)phenyl]-9H-carbazole (abbreviation: PCzPA), 3-[4-(1-naphthyl)-phenyl]-9-phenyl-9H-carbazole (abbreviation: PCPN), 9-[4-(10-phenyl-9-anthracenyl)phenyl]-9H-carbazole (abbreviation: CzPA), 7-[4-(10-phenyl-9-anthryl)phenyl]-7H-dibenzo[c,g]carbazole (abbreviation: cgDBCzPA), 6-[3-(9,10-diphenyl-2-anthryl)phenyl]-benzo[b]naphtho[1,2-d]furan (abbreviation: 2mBnfPPA), 9-phenyl-10-{4-(9-phenyl-9H-fluoren-9-yl)biphenyl-4′-yl}anthracene (abbreviation: FLPPA), 5,12-diphenyltetracene, and 5,12-bis(biphenyl-2-yl)tetracene.

In the case where the light-emitting substance is a phosphorescent material, an organic compound having triplet excitation energy (energy difference between a ground state and a triplet excited state) which is higher than that of the light-emitting substance is preferably selected. In that case, it is possible to use a zinc- or aluminum-based metal complex, an oxadiazole derivative, a triazole derivative, a benzimidazole derivative, a quinoxaline derivative, a dibenzoquinoxaline derivative, a dibenzothiophene derivative, a dibenzofuran derivative, a pyrimidine derivative, a triazine derivative, a pyridine derivative, a bipyridine derivative, a phenanthroline derivative, an aromatic amine, a carbazole derivative, and the like.

Specific examples include metal complexes such as tris(8-quinolinolato)aluminum(III) (abbreviation: Alq), tris(4-methyl-8-quinolinolato)aluminum(III) (abbreviation: Almq₃), bis(10-hydroxybenzo[h]quinolinato)beryllium(II) (abbreviation: BeBq₂), bis(2-methyl-8-quinolinolato) (4-phenylphenolato)aluminum(III) (abbreviation: BAlq), bis(8-quinolinolato)zinc(II) (abbreviation: Znq), bis[2-(2-benzoxazolyl)phenolato]zinc(II) (abbreviation: ZnPBO), and bis[2-(2-benzothiazolyl)phenolato]zinc(II) (abbreviation: ZnBTZ); heterocyclic compounds such as 2-(4-biphenylyl)-5-(4-tert-butylphenyl)-1,3,4-oxadiazole (abbreviation: PBD), 1,3-bis[5-(p-tert-butylphenyl)-1,3,4-oxadiazol-2-yl]benzene (abbreviation: OXD-7), 3-(4-biphenylyl)-4-phenyl-5-(4-tert-butylphenyl)-1,2,4-triazole (abbreviation: TAZ), 2,2′,2″-(1,3,5-benzenetriyl)-tris(1-phenyl-1H-benzimidazole) (abbreviation: TPBI), bathophenanthroline (abbreviation: BPhen), bathocuproine (abbreviation: BCP), 2,9-bis(naphthalen-2-yl)-4,7-diphenyl-1,10-phenanthroline (abbreviation: NBphen), and 9-[4-(5-phenyl-1,3,4-oxadiazol-2-yl)phenyl]-9H-carbazole (abbreviation: CO11); and aromatic amine compounds such as NPB, TPD, and BSPB.

In addition, condensed polycyclic aromatic compounds such as anthracene derivatives, phenanthrene derivatives, pyrene derivatives, chrysene derivatives, and dibenzo[g,p]chrysene derivatives can be used. Specifically, 9,10-diphenylanthracene (abbreviation: DPAnth), N,N-diphenyl-9-[4-(10-phenyl-9-anthryl)phenyl]-9H-carbazol-3-amine (abbreviation: CzA1PA), 4-(10-phenyl-9-anthryl)triphenylamine (abbreviation: DPhPA), YGAPA, PCAPA, N,9-diphenyl-N-{4-[4-(10-phenyl-9-anthryl)phenyl]phenyl}-9H-carbazol-3-amine (abbreviation: PCAPBA), 2PCAPA, 6,12-dimethoxy-5,11-diphenylchrysene, DBC1, 9-[4-(10-phenyl-9-anthracenyl)phenyl]-9H-carbazole (abbreviation: CzPA), 3,6-diphenyl-9-[4-(10-phenyl-9-anthryl)phenyl]-9H-carbazole (abbreviation: DPCzPA), 9,10-bis(3,5-diphenylphenyl)anthracene (abbreviation: DPPA), 9,10-di(2-naphthyl)anthracene (abbreviation: DNA), 2-tert-butyl-9,10-di(2-naphthyl)anthracene (abbreviation: t-BuDNA), 9,9′-bianthryl (abbreviation: BANT), 9,9′-(stilbene-3,3′-diyl)diphenanthrene (abbreviation: DPNS), 9,9′-(stilbene-4,4′-diyl)dipbenanthrene (abbreviation: DPNS2), 1,3,5-tri(1-pyrenyl)benzene (abbreviation: TPB3), or the like can be used.

In the case where a plurality of organic compounds are used for the light-emitting layers (413a and 413b), it is preferable to use compounds that form an exciplex in combination with each other. In that case, although any of various organic compounds can be combined appropriately to be used, to form an exciplex efficiently, it is particularly preferable to combine a compound that easily accepts holes (a hole-transport material) and a compound that easily accepts electrons (an electron-transport material). As the hole-transport material and the electron-transport material, specifically, any of the materials described in this embodiment can be used.

The TADF material is a material that can up-convert a triplet excited state into a singlet excited state (i.e., reverse intersystem crossing is possible) using a little thermal energy and efficiently exhibits light emission (fluorescence) from the singlet excited state. The TADF is efficiently obtained under the condition where the difference in energy between the triplet excited level and the singlet excited level is greater than or equal to 0 eV and less than or equal to 0.2 eV, preferably greater than or equal to 0 eV and less than or equal to 0.1 eV. Note that “delayed fluorescence” exhibited by the TADF material refers to light emission having the same spectrum as normal fluorescence and an extremely long lifetime. The lifetime is 10⁻⁶ seconds or longer, preferably 10⁻³ seconds or longer.

Specific examples of the TADF material include fullerene, a derivative thereof, an acridine derivative such as proflavine, and eosin. Other examples include a metal-containing porphyrin, such as a porphyrin containing magnesium (Mg), zinc (Zn), cadmium (Cd), tin (Sn), platinum (Pt), indium (In), or palladium (Pd). Examples of the metal-containing porphyrin include a protoporphyrin-tin fluoride complex (SnF₂(Proto IX)), a mesoporphyrin-tin fluoride complex (SnF₂(Meso IX)), a hematoporphyrin-tin fluoride complex (SnF₂(Hemato IX)), a coproporphyrin tetramethyl ester-tin fluoride complex (SnF₂(Copro III-4Me)), an octaethylporphyrin-tin fluoride complex (SnF₂(OEP)), an etioporphyrin-tin fluoride complex (SnF₂(Etio I)), and an octaethylporphyrin-platinum chloride complex (PtCl₂OEP).

Alternatively, a heterocyclic compound having a π-electron rich heteroaromatic ring and a π-electron deficient heteroaromatic ring, such as 2-(biphenyl-4-yl)-4,6-bis(12-phenylindolo[2,3-a]carbazol-11-yl)-1,3,5-triazine (PIC-TRZ), 2-{4-[3-(N-phenyl-9H-carbazol-3-yl)-9H-carbazol-9-yl]phenyl}-4,6-diphenyl-1,3,5-triazine (PCCzPTzn), 2-[4-(10 OH-phenoxazin-10-yl)phenyl]-4,6-diphenyl-1,3,5-triazine (PXZ-TRZ), 3-[4-(5-phenyl-5,10-dihydrophenazin-10-yl)phenyl]-4,5-diphenyl-1,2,4-triazole (PPZ-3TPT), 3-(9,9-dimethyl-9H-acridin-10-yl)-9H-xanthen-9-one (ACRXTN), bis[4-(9,9-dimethyl-9,10-dihydroacridine)phenyl]sulfone (DMAC-DPS), or 10-phenyl-10H,10′H-spiro[acridin-9,9′-anthracen]-10′-one (ACRSA) can be used. Note that a substance in which the π-electron rich heteroaromatic ring is directly bonded to the π-electron deficient heteroaromatic ring is particularly preferable because both the donor property of the π-electron rich heteroaromatic ring and the acceptor property of the π-electron deficient heteroaromatic ring are increased and the energy difference between the singlet excited state and the triplet excited state becomes small.

Note that when a TADF material is used, the TADF material can be combined with another organic compound.

Next, in the light-emitting element in FIG. 4D, the electron-transport layer 414a is formed over the light-emitting layer 413a of the EL layer 403a by a vacuum evaporation method. After the EL layer 403a and the charge generation layer 404 are formed, the electron-transport layer 414b is formed over the light-emitting layer 413b of the EL layer 403b by a vacuum evaporation method.

### <Electron-Transport Layer>

The electron-transport layers (414a and 414b) transport the electrons, which are injected from the second electrode 402 by the electron-injection layers (415a and 415b), to the light-emitting layers (413a and 413b). Note that the electron-transport layers (414a and 414b) each contain an electron-transport material. It is preferable that the electron-transport materials included in the electron-transport layers (414a and 414b) be substances with an electron mobility of higher than or equal to 1×10⁻⁶ cm²/Vs. Note that other substances may also be used as long as the substances have an electron-transport property higher than a hole-transport property.

Examples of the electron-transport material include metal complexes having a quinoline ligand, a benzoquinoline ligand, an oxazole ligand, and a thiazole ligand; an oxadiazole derivative; a triazole derivative; a phenanthroline derivative; a pyridine derivative; and a bipyridine derivative. In addition, a π-electron deficient heteroaromatic compound such as a nitrogen-containing heteroaromatic compound can also be used.

Specifically, it is possible to use metal complexes such as Alq₃, tris(4-methyl-8-quinolinolato)aluminum (abbreviation: Almq₃), bis(10-hydroxybenzo[h]quinolinato)beryllium (abbreviation: BeBq₂), BAlq, Zn(BOX)₂, and bis[2-(2-hydroxyphenyl)benzothiazolato]zinc (abbreviation: Zn(BTZ)₂), heteroaromatic compounds such as 2-(4-biphenylyl)-5-(4-tert-butylphenyl)-1,3,4-oxadiazole (abbreviation: PBD), 1,3-bis[5-(p-tert-butylphenyl)-1,3,4-oxadiazol-2-yl]benzene (abbreviation: OXD-7), 3-(4′-tert-butylphenyl)-4-phenyl-5-(4″-biphenyl)-1,2,4-triazole (abbreviation: TAZ), 3-(4-tert-butylphenyl)-4-(4-ethylphenyl)-5-phenylhenylyl)-1,2,4-triazole (abbreviation: p-EtTAZ), bathophenanthroline (abbreviation: Bphen), bathocuproine (abbreviation: BCP), and 4,4′-bis(5-methylbenzoxazol-2-yl)stilbene (abbreviation: BzOs), and quinoxaline derivatives and dibenzoquinoxaline derivatives such as 2-[3-(dibenzothiophen-4-yl)phenyl]dibenzo[f,h]quinoxaline (abbreviation: 2mDBTPDBq-II), 2-[3′-(dibenzothiophen-4-yl)biphenyl-3-yl]dibenzo[f,h]quinoxaline (abbreviation: 2mDBTBPDBq-II), 2-[4-(3,6-diphenyl-9H-carbazol-9-yl)phenyl]dibenzo[f,h]quinoxaline (abbreviation: 2CzPDBq-III), 7-[3-(dibenzothiophen-4-yl)phenyl]dibenzo[f,h]quinoxaline (abbreviation: 7mDBTPDBq-II), and 6-[3-(dibenzothiophen-4-yl)phenyl]dibenzo[f,h]quinoxaline (abbreviation: 6mDBTPDBq-II).

Alternatively, a high molecular compound such as poly(2,5-pyridinediyl) (abbreviation: PPy), poly[(9,9-dihexylfluorene-2,7-diyl)-co-(pyridine-3,5-diyl)] (abbreviation: PF-Py), or poly[(9,9-dioctylfluorene-2,7-diyl)-co-(2,2′-bipyridine-6,6′-diyl)] (abbreviation: PF-BPy) can be used.

Each of the electron-transport layers (414a and 414b) is not limited to a single layer, but may be a stack of two or more layers each containing any of the above substances.

Next, in the light-emitting element in FIG. 4D, the electron-injection layer 415a is formed over the electron-transport layer 414a of the EL layer 403a by a vacuum evaporation method. Subsequently, the EL layer 403a and the charge generation layer 404 are formed, the components up to the electron-transport layer 414b of the EL layer 403b are formed and then, the electron-injection layer 415b is formed thereover by a vacuum evaporation method.

### <<Electron-Injection Layer>>

The electron-injection layers (415a and 415b) each contain a substance having a high electron-injection property. For the electron-injection layers (415a and 415b), an alkali metal, an alkaline earth metal, or a compound thereof, such as lithium fluoride (LiF), cesium fluoride (CsF), calcium fluoride (CaF₂), or lithium oxide (LiOₓ), can be used. Alternatively, a rare earth metal compound like erbium fluoride (ErF₃) can be used. Electride may also be used for the electron-injection layers (415a and 415b). Examples of the electride include a substance in which electrons are added at a high concentration to calcium oxide-aluminum oxide. Any of the substances for forming the electron-transport layers (414a and 414b), which are given above, can also be used.

Alternatively, the electron-injection layers (415a and 415b) may be formed using a composite material in which an organic compound and an electron donor (donor) are mixed. The composite material is superior in an electron-injection property and an electron-transport property, since electrons are generated in the organic compound by the electron donor. The organic compound here is preferably a material excellent in transporting the generated electrons; specifically, for example, it is possible to use any of the above-described electron-transport materials (e.g., a metal complex and a heteroaromatic compound) that can be used for the electron-transport layers (414a and 414b). As the electron donor, a substance showing an electron-donating property with respect to the organic compound may be used. Specifically, an alkali metal, an alkaline earth metal, and a rare earth metal are preferable, and lithium, cesium, magnesium, calcium, erbium, ytterbium, and the like can be given. Further, an alkali metal oxide or an alkaline earth metal oxide is preferable, and for example, lithium oxide, calcium oxide, barium oxide, and the like can be given. Alternatively, a Lewis base such as magnesium oxide can also be used. An organic compound such as tetrathiafulvalene (abbreviation: TTF) can also be used.

In the case where light obtained from the light-emitting layer 413b is amplified, for example, the optical path length between the second electrode 402 and the light-emitting layer 413b is preferably less than one fourth of the wavelength λ of light emitted by the light-emitting layer 413b. In that case, the optical path length can be adjusted by changing the thickness of the electron-transport layer 414b or the electron-injection layer 415b.

### <Charge Generation Layer>

The charge generation layer 404 has a function of injecting electrons into the EL layer 403a and injecting holes into the EL layer 403b when a voltage is applied between the first electrode (anode) 401 and the second electrode (cathode) 402. The charge generation layer 404 may have either a structure in which an electron acceptor (acceptor) is added to a hole-transport material or a structure in which an electron donor (donor) is added to an electron-transport material. Alternatively, both of these structures may be stacked. Note that forming the charge generation layer 404 by using any of the above materials can suppress an increase in drive voltage caused by the stack of the EL layers.

In the case where the charge generation layer 404 has a structure in which an electron acceptor is added to a hole-transport material, any of the materials described in this embodiment can be used as the hole-transport material. Further, as the electron acceptor, 7,7,8,8-tetracyano-2,3,5,6-tetrafluoroquinodimethane (abbreviation: F₄-TCNQ), chloranil, and the like can be given. In addition, an oxide of metals that belong to Group 4 to Group 8 of the periodic table can be given. Specific examples are vanadium oxide, niobium oxide, tantalum oxide, chromium oxide, molybdenum oxide, tungsten oxide, manganese oxide, rhenium oxide, and the like.

In the case where the charge generation layer 404 has a structure in which an electron donor is added to an electron-transport material, any of the materials described in this embodiment can be used as the electron-transport material. As the electron donor, it is possible to use an alkali metal, an alkaline earth metal, a rare earth metal, metals belonging to Groups 2 and 13 of the periodic table, or an oxide or a carbonate thereof. Specifically, lithium (Li), cesium (Cs), magnesium (Mg), calcium (Ca), ytterbium (Yb), indium (In), lithium oxide, cesium carbonate, or the like is preferably used. Alternatively, an organic compound such as tetrathianaphthacene may be used as the electron donor.

### <Substrate>

The light-emitting element described in this embodiment can be formed over any of a variety of substrates. Note that the type of a substrate is not limited to a certain type. Examples of the substrate include a semiconductor substrate (e.g., a single crystal substrate or a silicon substrate), an SOI substrate, a glass substrate, a quartz substrate, a plastic substrate, a metal substrate, a stainless steel substrate, a substrate including stainless steel foil, a tungsten substrate, a substrate including tungsten foil, a flexible substrate, an attachment film, paper including a fibrous material, and a base material film.

Examples of the glass substrate include a barium borosilicate glass substrate, an aluminoborosilicate glass substrate, and a soda lime glass substrate. Examples of a flexible substrate, an attachment film, and a base material film include plastics typified by fiber-reinforced plastics (FRP), polyvinyl fluoride (PVF), polyethylene terephthalate (PET), polyethylene naphthalate (PEN), and polyether sulfone (PES); a synthetic resin such as acrylic; polypropylene; polyester, polyvinyl fluoride; polyvinyl chloride; polyamide; polyimide; aramid; epoxy; an inorganic vapor deposition film; and paper.

For fabrication of the above light-emitting element, a vacuum process such as an evaporation method or a solution process such as a spin coating method or an ink-jet method can be used. When an evaporation method is used, a physical vapor deposition method (PVD method) such as a sputtering method, an ion plating method, an ion beam evaporation method, a molecular beam evaporation method, or a vacuum evaporation method, a chemical vapor deposition method (CVD method), or the like can be used. Specifically, the functional layers (the hole-injection layers (411a and 411b), the hole-transport layers (412a and 412b), the light-emitting layers (413a and 413b), the electron-transport layers (414a and 414b), the electron-injection layers (415a and 415b)) included in the EL layers and the charge generation layer 404 of the light-emitting element can be formed by an evaporation method (e.g., a vacuum evaporation method), a coating method (e.g., a dip coating method, a die coating method, a bar coating method, a spin coating method, or a spray coating method), a printing method (e.g., an ink-jet method, screen printing (stencil), offset printing (planography), flexography (relief printing), gravure printing, or micro-contact printing), or the like.

Note that materials that can be used for the functional layers (the hole-injection layers (411a and 411b), the hole-transport layers (412a and 412b), the light-emitting layers (413a and 413b), the electron-transport layers (414a and 414b), and the electron-injection layers (415a and 415b)) that are included in the EL layers (403a and 403b) and the charge generation layer 404 in the light-emitting element described in this embodiment are not limited to the above materials, and other materials can be used in combination as long as the functions of the layers are fulfilled. For example, a high molecular compound (e.g., an oligomer, a dendrimer, or a polymer), a middle molecular compound (a compound between a low molecular compound and a high molecular compound with a molecular weight of 400 to 4000), an inorganic compound (e.g., a quantum dot material), or the like can be used. The quantum dot may be a colloidal quantum dot, an alloyed quantum dot, a core-shell quantum dot, a core quantum dot, or the like.

### <<Structure of Display Device>>

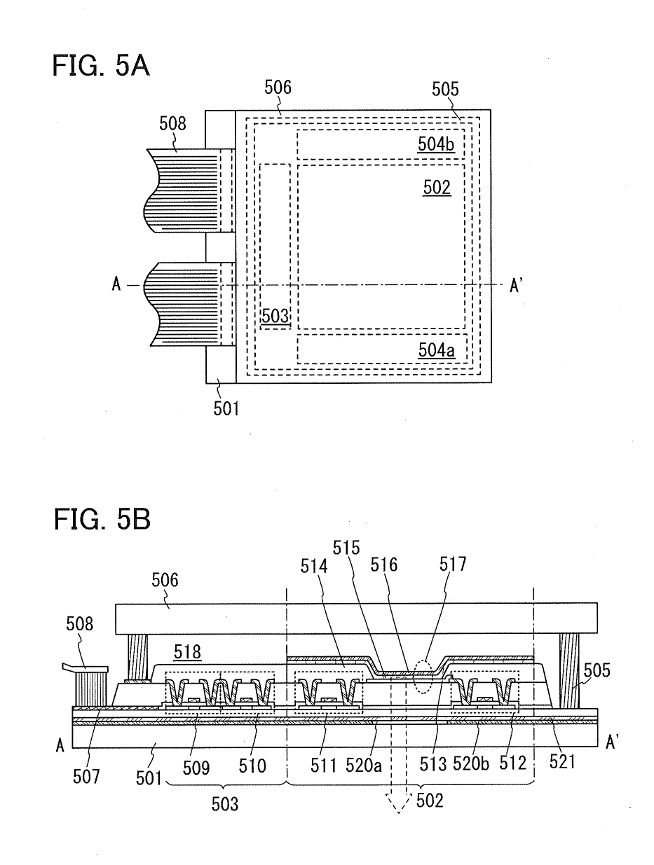

Next, an example of a display device including the above-described structure in FIGS. 3A to 3C and FIGS. 4A to 4D is described with reference to FIGS. 5A and 5B.

FIG. 5A is a top view illustrating a display device and FIG. 5B is a cross-sectional view taken along chain line A-A′ in FIG. 5A. The display device described here includes a pixel portion 502, a driver circuit portion (a source line driver circuit) 503, and driver circuit portions (gate line driver circuits) (504a and 504b) that are provided over a first substrate 501. The pixel portion 502 and the driver circuit portions (503, 504a, and 504b) are sealed between the first substrate 501 and a second substrate 506 with a sealant 505.

A lead wiring 507 is provided over the first substrate 501. The lead wiring 507 is connected to an FPC 508 that is an external input terminal. Note that the FPC 508 transmits a signal (e.g., a video signal, a clock signal, a start signal, or a reset signal) or a potential from the outside to the driver circuit portions (503, 504a, and 504b). The FPC 508 may be provided with a printed wiring board (PWB). Note that the state in which an FPC and a PWB are provided is included in the category of a display device.

FIG. 5B illustrates a cross-sectional structure of the display device. The pixel portion 502 includes a light-emitting element 517, a transistor (FET), a wiring, and the like, and the driver circuit portion 503 includes an FET 509, an FET 510, a wiring, and the like. Although not illustrated, the light-emitting element 517 is formed in a display element layer, and the FET 509 and the FET 510 are formed in a driving element layer.

Therefore, a first organic layer 520a of an organic layer 520 is provided in a position overlapping with the light-emitting element 517. Furthermore, a second organic layer 520b of the organic layer 520 is provided in a position overlapping with the transistor (FET), the wiring, or the like (a position where light from the light-emitting element 517 is not transmitted). The first organic layer 520a provided in the position overlapping with the light-emitting element 517 transmits light emitted from an EL layer 515 of the light-emitting element 517. Thus, the first organic layer 520a is formed using a material that can transmit visible light. Note that in the case where the organic layer 520 consists of the second organic layer 520b and transmission of light emitted from the light-emitting element 517 through the second organic layer 520b does not significantly reduce the light extraction efficiency of the light-emitting element 517, the first organic layer 520a does not need to be provided as part of the organic layer 520 in a position overlapping with the light-emitting element 517, and the organic layer 520 may consist of the second organic layer 520b.

As the transistors (FETs), an FET (a switching FET) 511, an FET (a current control FET) 512, and the like are provided and the FET (the current control FET) 512 is electrically connected to a first electrode 513 of the light-emitting element 517. Note that the number of FETs included in each pixel is not particularly limited and can be set appropriately.

As the FETs 509, 510, 511, and 512, for example, a staggered transistor or an inverted staggered transistor can be used without particular limitation. Furthermore, a top-gate transistor, a bottom-gate transistor, or the like may be used.

Further, there is no particular limitation on the crystallinity of semiconductors that can be used for the FETs 509, 510, 511, and 512, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of the transistor characteristics can be suppressed.

As the semiconductors, a Group 14 element, a compound semiconductor, an oxide semiconductor, an organic semiconductor, or the like can be used, for example. Typically, a semiconductor containing silicon, a semiconductor containing gallium arsenide, an oxide semiconductor containing indium, or the like can be used.

In the driver circuit portion 503, the FET 509 and the FET 510 may be formed with a circuit including transistors having the same conductivity type (either an n-channel transistor or a p-channel transistor) or a CMOS circuit including an n-channel transistor and a p-channel transistor. Furthermore, a driver circuit may be provided outside.

Note that a second electrode 516 of the light-emitting element 517 is electrically connected to the FPC 508 that is an external input terminal.

The display device in this embodiment includes, as illustrated in FIG. 5B, the transistors (FETs) (509, 510, 511, and 512), the light-emitting element 517, the wiring, the organic layer 520 (the first organic layer 520a and the second organic layer 520b), a retardation layer 521, and the like between the first substrate 501 and the second substrate 506. By bonding the second substrate 506 and the first substrate 501 to each other with the sealant 505, the display device has a structure in which the above components are provided in a space 518 surrounded by the first substrate 501, the second substrate 506, and the sealant 505. Note that the space 518 may be filled with an inert gas (e.g., nitrogen or argon) or an organic substance (including the sealant 505).

It is preferable that the sealant 505 should not transmit moisture or oxygen as much as possible. For example, an epoxy-based resin, glass frit, or the like can be used for the sealant 505. Note that when glass frit is used, glass is preferably used as a substrate material.

When the first substrate 501 and the second substrate 506 of the display device described in this embodiment are flexible substrates, the FETs and the light-emitting element may be directly formed over the flexible substrates; alternatively, the FETs and the light-emitting element may be formed over a substrate provided with a separation layer and then separated at the separation layer by application of heat, force, laser, or the like to be transferred to a flexible substrate. For the separation layer, a stack including inorganic films such as a tungsten film and a silicon oxide film, or an organic resin film of polyimide or the like can be used, for example. Examples of the flexible substrate include, in addition to the substrates over which a transistor can be formed, a paper substrate, a cellophane substrate, an aramid film substrate, a polyimide film substrate, a cloth substrate (including a natural fiber (e.g., silk, cotton, or hemp), a synthetic fiber (e.g., nylon, polyurethane, or polyester), a regenerated fiber (e.g., acetate, cupra, rayon, or regenerated polyester), or the like), a leather substrate, and a rubber substrate. With the use of any of these substrates, an increase in durability or heat resistance and a reduction in weight or thickness can be achieved.

The structure described in this embodiment can be used in appropriate combination with the structure described in any of other embodiments.

### Embodiment 4

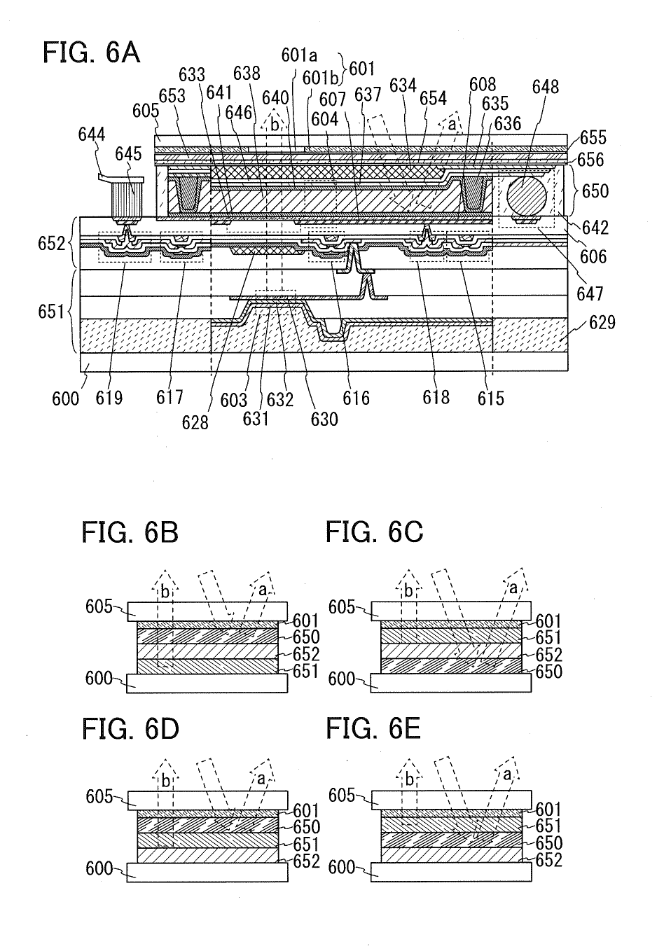

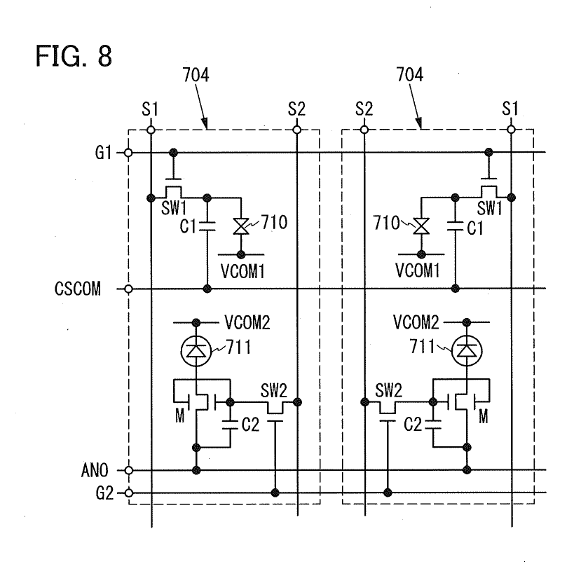

In this embodiment, a display device which has a first element layer including a liquid crystal element and a second element layer including a light-emitting element and in which the display elements can perform the respective kinds of display is described as a display device of one embodiment of the present invention with reference to FIGS. 6A to 6E, FIGS. 7A, 7131, and 7B2, and FIG. 8. Such a display device can also be referred to as an emissive OLED and reflective LC hybrid display (ER-hybrid display).

Note that the display device in this embodiment, which can perform both display using the liquid crystal element and display using the light-emitting element, can be driven with extremely low power consumption in the outdoors and other bright places where external light is intense when a reflective liquid crystal element is used as the liquid crystal element because the display can be performed with the reflective liquid crystal element utilizing the external light. On the other hand, the display device can perform image display with a wide viewing angle and a high color reproducibility and can be driven with low power consumption in the nighttime or in the indoors and other dark places where external light is weak when the light-emitting element, which does not need a light source, is used. Alternatively, a structure can be employed in which a transmissive (or a semi-transmissive and semi-reflective electrode) liquid crystal element is used as the liquid crystal element and the light-emitting element is used as both the light source of the liquid crystal element and a display element. Thus, by combination of these modes, the display device can display an image with low power consumption and a high color reproducibility compared to a conventional display panel.

In the display device illustrated in FIGS. 6A to 6E, a first element layer (a display element layer) 650 including a reflective liquid crystal element 604 and a second element layer (a display element layer) 651 including a light-emitting element 603 are stacked. In a first mode, display with the liquid crystal element 604 is performed by reflection of visible light on a first electrode (reflective electrode) 607. In a second mode, display is performed by emission of light from the light-emitting element 603 through an opening 633 in the first electrode (reflective electrode) 607. Note that these elements (the liquid crystal element 604 and the light-emitting element 603) are driven with transistors (615 and 616) formed in a third element layer (driving element layer) 652 (on the same plane). Thus, the third element layer 652 is stacked with the first element layer 650 and the second element layer 651. The display device in FIGS. 6A to 6E includes an organic layer 601 between a pair of substrates, between which these element layers are provided, and light from the element layer is transmitted through the organic layer 601 and then emitted to the outside of the substrate.

FIGS. 6A to 6E illustrate examples of the display device having the above structure. In the stacked-layer structures illustrated in FIGS. 6A to 6C, the third element layer 652 is provided between the first element layer 650 and the second element layer 651. It is preferable that insulating layers be provided between the liquid crystal element 604 included in the first element layer 650, the light-emitting element 603 included in the second element layer 651, and the transistors (615 and 616) included in the third element layer 652 when the element layers are stacked.

### <<Structure of Display Device>>

An example of a display device including the above-described structure is described with reference to FIGS. 6A to 6E.

In the display device, the first element layer 650 including the liquid crystal element 604, the second element layer 651 including the light-emitting element 603, the third element layer 652 including the transistors (driving elements) (615 and 616), the organic layer 601 including a first organic layer 601a and a second organic layer 601b, a retardation layer 653 (or a retardation film), and a diffusion layer 654 (or a diffusion film) are provided between a first substrate 600 and a second substrate 605. Owing to the retardation layer 653, light that is transmitted through a liquid crystal layer 638 can be extracted to the outside. Note that by adjusting the phase difference between the retardation layer 653 and the liquid crystal layer 638, the amount of transmitted light can be adjusted. The diffusion layer 654 can prevent light that is reflected by the first electrode 607 serving as a reflective electrode from being metallic white because of an electrode material when a white image is displayed. As illustrated in FIG. 6A, an insulating layer 655 may be provided between the organic layer 601 and the retardation layer 653 and an insulating layer 656 may be provided between the diffusion layer 654 and the coloring layer 634.

Note that the first element layer 650 including the liquid crystal element 604, the second element layer 651 including the light-emitting element 603, and the third element layer 652 including the transistors (driving elements) (615, 616, and 617) can be stacked by a technique in which the layers are formed separately, peeled, and bonded to each other. Note that in the case where the stacked-layer structure is formed by bonding in the above manner, the element layers are stacked with insulating layers provided therebetween. The elements (the liquid crystal element 604, the light-emitting element 603, the transistors (615, 616, and 617), and the like) formed in the element layers can be electrically connected via conductive films (wirings) formed in the insulating layers that insulate the elements from one another.

The liquid crystal element 604 included in the first element layer 650 is a reflective liquid crystal element and the first electrode 607 serves as a reflective electrode; thus, the first electrode 607 is formed using a material with high reflectivity. Note that the first electrode 607 includes the opening 633. Furthermore, a conductive layer 608 serves as a transparent electrode, and thus is formed using a material that transmits visible light. The first electrode 607 and the conductive layer 608 are in contact with each other and function as one electrode of the liquid crystal element 604. A conductive layer 637 functions as the other electrode of the liquid crystal element 604. Alignment films 640 and 641 are provided on the conductive layers 608 and 637 and in contact with the liquid crystal layer 638. An insulating layer 646 is provided so as to cover the coloring layer 634 and a light-blocking layer 635 and serves as an overcoat. Note that the alignment films 640 and 641 are not necessarily provided.

A spacer 636 has a function of inhibiting the pair of electrodes of the liquid crystal element 604 from getting closer to each other than necessary (a function of maintaining a cell gap). The spacer 636 is not necessarily provided.

The light-emitting element 603 included in the second element layer 651 has a stacked-layer structure in which an EL layer 632 is provided between a conductive layer 630 serving as one electrode and a conductive layer 631 serving as the other electrode. Note that the conductive layer 630 includes a material transmitting visible light and the conductive layer 631 includes a material reflecting visible light. Therefore, light emitted from the light-emitting element 603 is transmitted through the conductive layer 630, the coloring layer 628, the opening 633, the liquid crystal element 604, and then the first organic layer 601a that is part of the organic layer 601 and can transmit visible light to be emitted to the outside through the second substrate 605.

One of a source and a drain of the transistor 615, which is one of the transistors (615, 616, and 617) included in the third element layer 652, is electrically connected to the first electrode 607 and a conductive layer 608 of the liquid crystal element 604 through a terminal portion 618. Note that the transistor 615 corresponds to a switch SW1 in FIG. 8 that will be described later. One of a source and a drain of the transistor 616 is electrically connected to the conductive layer 630 in the light-emitting element 603. For example, the transistor 616 corresponds to a transistor M in FIG. 8.

A terminal portion 619, like the terminal portion 618, electrically connects conductive layers to each other. Thus, the terminal portion 619 and an FPC 644 can be electrically connected to each other through a connection layer 645.

A connection portion 647 is provided in part of a region where a bonding layer 642 is provided. In the connection portion 647, the conductive layer obtained by processing the same conductive film as the first electrode 607 and the conductive layer 608 and part of the conductive layer 637 are electrically connected with a connector 648. Accordingly, a signal or a potential input from the FPC 644 can be supplied to the first electrode 607 and the conductive layer 608 through the connection portion 647.

Although FIG. 6A illustrates the structure in FIG. 6B in which the second element layer 651 including the light-emitting element, the third element layer 652 including the transistors, and the first element layer 650 including the liquid crystal element are stacked between the first substrate 600 and the second substrate 605 from the first substrate 600 side, the stacked-layer structure is not limited to this and may be, for example, a structure in which the first element layer 650, the third element layer 652, and the second element layer 651 are stacked in this order as illustrated in FIG. 6C, a structure in which the third element layer 652, the second element layer 651, and the first element layer 650 are stacked in this order as illustrated in FIG. 6D, or a structure in which the third element layer 652, the first element layer 650, and the second element layer 651 are stacked in this order as illustrated in FIG. 6E.

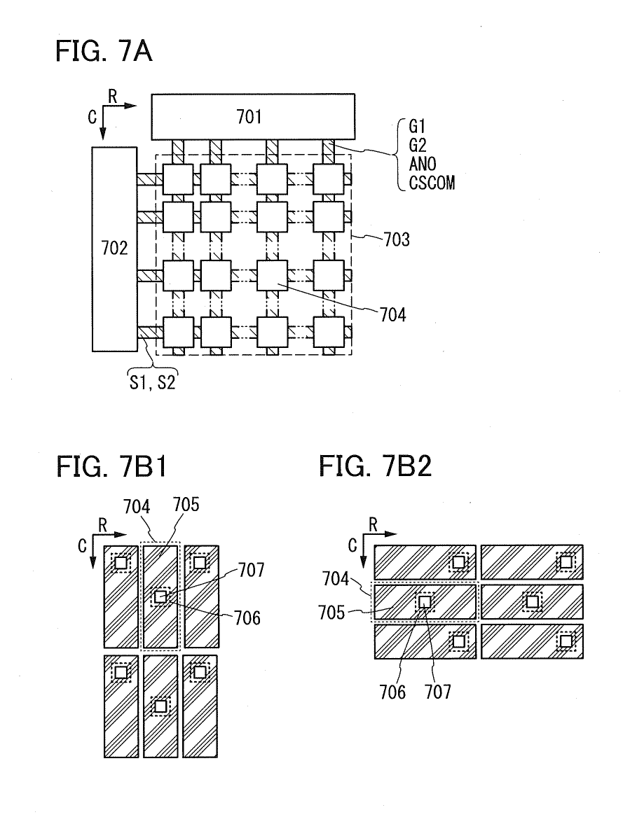

FIG. 7A is a block diagram illustrating a display device. The display device includes a circuit (G) 701, a circuit (S) 702, and a display portion 703. In the display portion 703, a plurality of pixels 704 are arranged in an R direction and a C direction in a matrix. A plurality of wirings G1, wirings G2, wirings ANO, and wirings CSCOM are electrically connected to the circuit (G) 701. These wirings are also electrically connected to the plurality of pixels 704 arranged in the R direction. A plurality of wirings S and wirings S2 are electrically connected to the circuit (S) 702, and these wirings are also electrically connected to the plurality of pixels 704 arranged in the C direction.

Each of the plurality of pixels 704 includes a liquid crystal element and a light-emitting element. The liquid crystal element and the light-emitting element partly overlap with each other.

FIG. 7B1 shows the shape of a conductive film 705 serving as a reflective electrode of the liquid crystal element included in the pixel 704. Note that an opening 707 is provided in the conductive film 705 in a position 706 which overlaps with the light-emitting element. That is, light emitted from the light-emitting element is emitted through the opening 707. Although not illustrated, the first organic layer 601a that is part of the organic layer 601 shown in FIGS. 6A to 6E and that can transmit visible light is formed in a position overlapping with this opening. The second organic layer 601b serving as a polarizer is formed in the entire pixel portion (which may include a circuit) except a portion where the first organic layer 601a is provided.

The pixels 704 in FIG. 7B1 are arranged such that adjacent pixels 704 in the R direction exhibit different colors. Furthermore, the openings 707 are provided so as not to be arranged in a line in the R direction. Such arrangement has an effect of suppressing crosstalk between the light-emitting elements of adjacent pixels 704. Furthermore, there is an advantage that element formation is facilitated.

The opening 707 can have a polygonal shape, a quadrangular shape, an elliptical shape, a circular shape, a cross shape, a stripe shape, or a slit-like shape, for example.

FIG. 7B2 illustrates another example of the arrangement of the conductive films 705.

The ratio of the opening 707 to the total area of the conductive film 705 (excluding the opening 707) affects the display of the display device. That is, a problem is caused in that as the area of the opening 707 becomes larger, the display using the liquid crystal element becomes darker, in contrast, as the area of the opening 707 becomes smaller, the display using the light-emitting element becomes darker. Furthermore, in addition to the problem of the ratio of the opening, a small area of the opening 707 itself also causes a problem in that extraction efficiency of light emitted from the light-emitting element is decreased. The ratio of the opening 707 to the total area of the conductive film 705 (other than the opening 707) is preferably 5% or more and 60% or less for maintaining visibility at the time of combination of the liquid crystal element and the light-emitting element.

Next, an example of a circuit configuration of the pixel 704 is described with reference to FIG. 8. FIG. 8 shows two adjacent pixels 704.

The pixel 704 includes the transistor SW1, a capacitor C1, a liquid crystal element 710, a transistor SW2, the transistor M, a capacitor C2, a light-emitting element 711, and the like. Note that these components are electrically connected to any of the wiring G1, the wiring G2, the wiring ANO, the wiring CSCOM, the wiring S1, and the wiring S2 in the pixel 704. The liquid crystal element 710 and the light-emitting element 711 are electrically connected to a wiring VCOM1 and a wiring VCOM2, respectively.

A gate of the transistor SW1 is connected to the wiring G1. One of a source and a drain of the transistor SW1 is connected to the wiring S1, and the other of the source and the drain is connected to one electrode of the capacitor C1 and one electrode of the liquid crystal element 710. The other electrode of the capacitor C1 is connected to the wiring CSCOM. The other electrode of the liquid crystal element 710 is connected to the wiring VCOM1.

A gate of the transistor SW2 is connected to the wiring G2. One of a source and a drain of the transistor SW2 is connected to the wiring S2, and the other of the source and the drain is connected to one electrode of the capacitor C2 and a gate of the transistor M. The other electrode of the capacitor C2 is connected to one of a source and a drain of the transistor M and the wiring ANO. The other of the source and the drain of the transistor M is connected to one electrode of the light-emitting element 711. Furthermore, the other electrode of the light-emitting element 711 is connected to the wiring VCOM2.

Note that the transistor M includes two gates between which a semiconductor is provided and which are electrically connected to each other. With such a structure, the amount of current flowing through the transistor M can be increased.

The on/off state of the transistor SW1 is controlled by a signal from the wiring G1. A predetermined potential is supplied from the wiring VCOM1. Furthermore, alignment of liquid crystals of the liquid crystal element 710 can be controlled by a signal from the wiring S1. A predetermined potential is supplied from the wiring CSCOM.

The on/off state of the transistor SW2 is controlled by a signal from the wiring G2. By the difference between the potentials applied from the wiring VCOM2 and the wiring ANO, the light-emitting element 711 can emit light. Furthermore, the on/off state of the transistor M can be controlled by a signal from the wiring S2.

In the above structure, in the case of the first mode, for example, the liquid crystal element 710 is controlled by the signals supplied from the wiring G1 and the wiring S1 and optical modulation is utilized, whereby display can be performed. In the case of the second mode, the light-emitting element 711 emits light when the signals are supplied from the wiring G2 and the wiring S2, whereby display can be performed. In the case where both modes are performed at the same time, desired display can be performed by the liquid crystal element 710 and the light-emitting element 711 on the basis of the signals from the wiring G1, the wiring G2, the wiring S1, and the wiring S2.

Note that the structure described in this embodiment can be combined as appropriate with any of the structures described in other embodiments.

### Embodiment 5

In this embodiment, an example of the transistor formed in the driving element layer included in the element layer of the display device of one embodiment of the present invention is described. As the transistor, for example, a planar transistor, a staggered transistor, an inverted staggered transistor, or the like can be used. A top-gate or bottom-gate transistor structure can be employed. Gate electrodes may be provided above and below a channel. Thus, there are no particular limitations on the structure of any of the transistors.

As a semiconductor material used for the semiconductor layer of the transistor, an element of Group 14 (e.g., silicon or germanium), a compound semiconductor, or an oxide semiconductor can be used, for example. A semiconductor containing silicon, a semiconductor containing gallium arsenide, an oxide semiconductor containing indium, or the like can be typically used.

There is no particular limitation on the crystallinity of a semiconductor material used for the semiconductor layer of the transistor, and an amorphous semiconductor or a semiconductor having crystallinity (a microcrystalline semiconductor, a polycrystalline semiconductor, a single crystal semiconductor, or a semiconductor partly including crystal regions) may be used. A semiconductor having crystallinity is preferably used, in which case deterioration of the transistor characteristics can be suppressed.

Among the above semiconductor materials used for the semiconductor layer of the transistor, it is particularly preferable to use a metal oxide.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, a metal oxide used in an active layer of a transistor is called an oxide semiconductor in some cases. In other words, an OS FET is a transistor including a metal oxide or an oxide semiconductor.

In this specification and the like, a metal oxide including nitrogen is also called a metal oxide in some cases. Moreover, a metal oxide including nitrogen may be called a metal oxynitride.

In this specification and the like, “c-axis aligned crystal (CAAC)” or “cloud-aligned composite (CAC)” might be stated. CAAC refers to an example of a crystal structure, and CAC refers to an example of a function or a material composition.

In this specification and the like, a CAC-OS or a CAC-metal oxide has a function of a conductor in a part of the material and has a function of a dielectric (or insulator) in another part of the material; as a whole, a CAC-OS or a CAC-metal oxide has a function of a semiconductor. In the case where a CAC-OS or a CAC-metal oxide is used in an active layer of a transistor, the conductor has a function of letting electrons (or holes) serving as carriers flow, and the dielectric has a function of not letting electrons serving as carriers flow. By the complementary action of the function as a conductor and the function as a dielectric, a CAC-OS or a CAC-metal oxide can have a switching function (on/off function). In the CAC-OS or CAC-metal oxide, separation of the functions can maximize each function.

In this specification and the like, a CAC-OS or a CAC-metal oxide includes conductor regions and dielectric regions. The conductor regions have the above-described function of the conductor, and the dielectric regions have the above-described function of the dielectric. In some cases, the conductor regions and the dielectric regions in the material are separated at the nanoparticle level. In some cases, the conductor regions and the dielectric regions are unevenly distributed in the material. When observed, the conductor regions are coupled in a cloud-like manner with their boundaries blurred, in some cases.

In other words, a CAC-OS or a CAC-metal oxide can be called a matrix composite or a metal matrix composite.

Furthermore, in the CAC-OS or CAC-metal oxide, each of the conductor regions and the dielectric regions has a size of more than or equal to 0.5 nm and less than or equal to 10 nm, preferably more than or equal to 0.5 nm and less than or equal to 3 nm and is dispersed in the material, in some cases.

Note that the following description is made on the assumption that a metal oxide is an oxide semiconductor.

This is because an oxide semiconductor is a semiconductor material having a wider band gap and a lower carrier density than silicon and can reduce the off-state current of a transistor. It is particularly preferable to use an oxide semiconductor having an energy gap of 2 eV or more, further preferably 2.5 eV or more, and still further preferably 3 eV or more.

When a transistor has a reduced off-state current, charge accumulated in a capacitor that is connected in series to the transistor can be held for a long time. Accordingly, when such a transistor is used for a pixel, operation of a driver circuit can be stopped while a gray scale of an image displayed in each display region is maintained. As a result, a display device with extremely low power consumption is obtained.

Next, the above-mentioned CAC-OS is described in detail.

The CAC-OS has, for example, a composition in which elements included in an oxide semiconductor are unevenly distributed. Materials including unevenly distributed elements each have a size of greater than or equal to 0.5 nm and less than or equal to 10 nm, preferably greater than or equal to 1 nm and less than or equal to 2 nm, or a similar size. Note that in the following description of an oxide semiconductor, a state in which one or more metal elements are unevenly distributed and regions including the metal element(s) are mixed is referred to as a mosaic pattern or a patch-like pattern. The region has a size of greater than or equal to 0.5 nm and less than or equal to 10 nm, preferably greater than or equal to 1 nm and less than or equal to 2 nm, or a similar size.

Note that an oxide semiconductor preferably contains at least indium. In particular, indium and zinc are preferably contained. In addition, an element M (one or more kinds of elements selected from aluminum, gallium, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like) may be contained.

For example, of the CAC-OS, an In—Ga—Zn oxide with the CAC composition (such an In—Ga—Zn oxide may be particularly referred to as CAC-IGZO) has a composition in which materials are separated into indium oxide (InO_{X1}, where X1 is a real number greater than 0) or indium zinc oxide (In_{X2}Zn_{Y2}O_{Z2}, where X2, Y2, and Z2 are real numbers greater than 0), and gallium oxide (GaO_{X3}, where X3 is a real number greater than 0) or gallium zinc oxide (Ga_{X4}Zn_{Y4}O_{Z4}, where X4, Y4, and Z4 are real numbers greater than 0), and a mosaic pattern is formed. Then, InO_{X1} or In_{X2}Zn_{Y2}O_{Z2} forming the mosaic pattern is evenly distributed in the film. This composition is also referred to as a cloud-like composition.

That is, the CAC-OS is a composite oxide semiconductor with a composition in which a region including GaO_{X3} as a main component and a region including In_{X2}Zn_{Y2}O_{Z2} or InO_{X1} as a main component are mixed. Note that in this specification, for example, when the atomic ratio of In to an element M in a first region is greater than the atomic ratio of In to the element M in a second region, the first region has higher In concentration than the second region.

Note that a compound including In, Ga, Zn, and O is also known as IGZO. Typical examples of IGZO include a crystalline compound represented by InGaO₃(ZnO)ₘ₁ (m1 is a natural number) and a crystalline compound represented by In₍₁₊ₓ₀₎Ga₍₁₋ₓ₀₎O₃(ZnO)ₘ₀ (−1≦x0≦1; m0 is a given number).

The above crystalline compounds have a single crystal structure, a polycrystalline structure, or a CAAC structure. Note that the CAAC structure is a crystal structure in which a plurality of IGZO nanocrystals have c-axis alignment and are connected in the a-b plane direction without alignment.

On the other hand, the CAC-OS relates to the material composition of an oxide semiconductor. In a material composition of a CAC-OS including In, Ga, Zn, and O, nanoparticle regions including Ga as a main component are observed in part of the CAC-OS and nanoparticle regions including In as a main component are observed in part thereof. These nanoparticle regions are randomly dispersed to form a mosaic pattern. Therefore, the crystal structure is a secondary element for the CAC-OS.

Note that in the CAC-OS, a stacked-layer structure including two or more films with different atomic ratios is not included. For example, a two-layer structure of a film including In as a main component and a film including Ga as a main component is not included.

A boundary between the region including GaO_{X3} as a main component and the region including In_{X2}Zn_{Y2}O_{Z2} or InO_{X1} as a main component is not clearly observed in some cases.

In the case where one or more of aluminum, yttrium, copper, vanadium, beryllium, boron, silicon, titanium, iron, nickel, germanium, zirconium, molybdenum, lanthanum, cerium, neodymium, hafnium, tantalum, tungsten, magnesium, and the like are contained instead of gallium in a CAC-OS, nanoparticle regions including the selected metal element(s) as a main component(s) are observed in part of the CAC-OS and nanoparticle regions including In as a main component are observed in part thereof, and these nanoparticle regions are randomly dispersed to form a mosaic pattern in the CAC-OS.

The CAC-OS can be formed by a sputtering method under conditions where a substrate is not heated intentionally, for example. In the case of forming the CAC-OS by a sputtering method, one or more selected from an inert gas (typically, argon), an oxygen gas, and a nitrogen gas may be used as a deposition gas. The ratio of the flow rate of an oxygen gas to the total flow rate of the deposition gas at the time of deposition is preferably as low as possible, and for example, the flow ratio of an oxygen gas is preferably higher than or equal to 0% and less than 30%, further preferably higher than or equal to 0% and less than or equal to 10%.

The CAC-OS is characterized in that no clear peak is observed in measurement using θ/2θ scan by an out-of-plane method, which is an X-ray diffraction (XRD) measurement method. That is, X-ray diffraction shows no alignment in the a-b plane direction and the c-axis direction in a measured region.

In an electron diffraction pattern of the CAC-OS which is obtained by irradiation with an electron beam with a probe diameter of 1 nm (also referred to as a nanometer-sized electron beam), a ring-like region with high luminance and a plurality of bright spots in the ring-like region are observed. Therefore, the electron diffraction pattern indicates that the crystal structure of the CAC-OS includes a nanocrystal (nc) structure with no alignment in plan-view and cross-sectional directions.

For example, an energy dispersive X-ray spectroscopy (EDX) mapping image confirms that an In—Ga—Zn oxide with the CAC composition has a structure in which a region including GaO_{X3} as a main component and a region including In_{X2}Zn_{Y2}O_{Z2} or InO_{X1} are unevenly distributed and mixed.

The CAC-OS has a structure different from that of an IGZO compound in which metal elements are evenly distributed, and has characteristics different from those of the IGZO compound. That is, in the CAC-OS, regions including GaO_{X3} or the like as a main component and regions including In_{X2}Zn_{Y2}O_{Z2} or InO_{X1} as a main component are separated to form a mosaic pattern.

The conductivity of a region including In_{X2}Zn_{Y2}O_{Z2} or InO_{X1} as a main component is higher than that of a region including GaO_{X3} or the like as a main component. In other words, when carriers flow through regions including In_{X2}Zn_{Y2}O_{Z2} or InO_{X1} as a main component, the conductivity of an oxide semiconductor is exhibited. Accordingly, when regions including In_{X2}Zn_{Y2}O_{Z2} or InO_{X1} as a main component are distributed in an oxide semiconductor like a cloud, high field-effect mobility (μ) can be achieved.

In contrast, the insulating property of a region including GaO_{X3} or the like as a main component is higher than that of a region including In_{X2}Zn_{Y2}O_{Z2} or InO_{X1} as a main component. In other words, when regions including GaO_{X3} or the like as a main component are distributed in an oxide semiconductor, leakage current can be suppressed and favorable switching operation can be achieved.

Accordingly, when a CAC-OS is used for a semiconductor layer of a transistor, the insulating property derived from GaO_{X3} or the like and the conductivity derived from In_{X2}Zn_{Y2}O_{Z2} or InO_{X1} complement each other, whereby high on-state current (Iₒₙ) and high field-effect mobility (μ) can be achieved.

When a CAC-OS is used for a semiconductor layer of a transistor, the transistor can have increased reliability.

It is preferable that the atomic ratio of metal elements of a sputtering target used for depositing the In-M-Zn-based oxide satisfy In≧M and Zn≧M. As the atomic ratio of metal elements of such a sputtering target, In:M:Zn=1:1:1, In:M:Zn=1:1:1.2, In:M:Zn=3:1:2, In:M:Zn=4:2:4.1, and the like are preferable. Note that the atomic ratio of metal elements in the formed film varies from the atomic ratio of those in the above-described sputtering target, within a range of ±40% as an error.

The formed film preferably has a low carrier density. An oxide semiconductor with a low carrier density has a low impurity concentration and a low density of defect states and can be regarded as an oxide semiconductor with stable characteristics. For example, for an oxide semiconductor film with a low carrier density, it is desirable to use an oxide semiconductor whose carrier density is lower than or equal to 1×10¹⁷/cm³, preferably lower than or equal to 1×10¹⁵/cm³, further preferably lower than or equal to 1×10¹³/cm³, still further preferably lower than or equal to 1×10¹¹/cm³, even further preferably lower than 1×10¹⁰/cm³, and higher than or equal to 1×10⁻⁹/cm³.

Note that without limitation to those described above, a material with an appropriate composition may be used depending on required semiconductor characteristics and electrical characteristics (e.g., field-effect mobility and threshold voltage) of a transistor. To obtain the required semiconductor characteristics of the transistor, it is preferable that the carrier density, the impurity concentration, the defect density, the atomic ratio between a metal element and oxygen, the interatomic distance, the density, and the like of the semiconductor layer be set to appropriate values.

Alkali metal and alkaline earth metal might generate carriers when bonded to an oxide semiconductor, in which case the off-state current of the transistor might be increased. Therefore, the concentration of alkali metal or alkaline earth metal of the semiconductor layer, which is measured by secondary ion mass spectrometry, is lower than or equal to 1×10¹⁸ atoms/cm³, preferably lower than or equal to 2×10¹⁶ atoms/cm³.

When an oxide semiconductor is used, the crystal structure thereof may be a non-single-crystal structure. Examples of the non-single-crystal structure include the above-described CAAC-OS, a polycrystalline structure, a microcrystalline structure, and an amorphous structure. Among the non-single-crystal structures, the amorphous structure has the highest density of defect states, whereas a CAAC-OS has the lowest density of defect states. The amorphous structure has disordered atomic arrangement or an absolutely amorphous structure and no crystal portion.

Note that the semiconductor layer may be a mixed film including two or more of the following: a region having an amorphous structure, a region having a microcrystalline structure, a region having a polycrystalline structure, a region of a CAAC-OS, and a region having a single-crystal structure. The mixed film has, for example, a single-layer structure or a stacked-layer structure including two or more of the above-described regions in some cases.

When a transistor in the driving element layer included in the element layer of the display device of one embodiment of the present invention is the transistor described in this embodiment, the display device can have high reliability.

Note that the structure described in this embodiment can be combined as appropriate with any of the structures described in other embodiments.

### Embodiment 6

In this embodiment, examples of a variety of electronic devices and an automobile manufactured using a display device of one embodiment of the present invention are described.

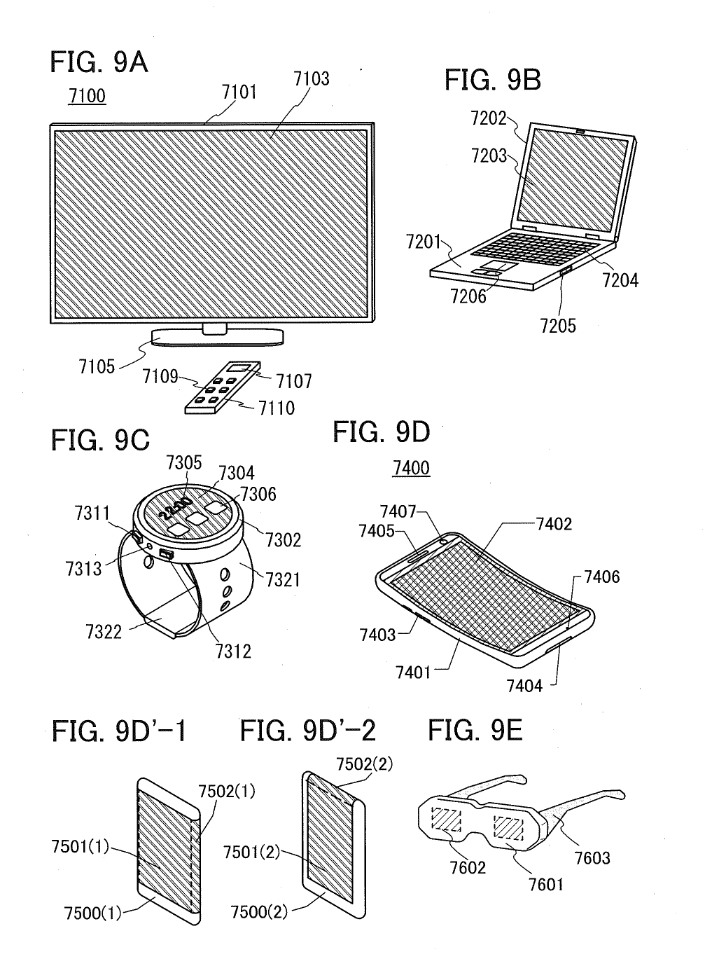

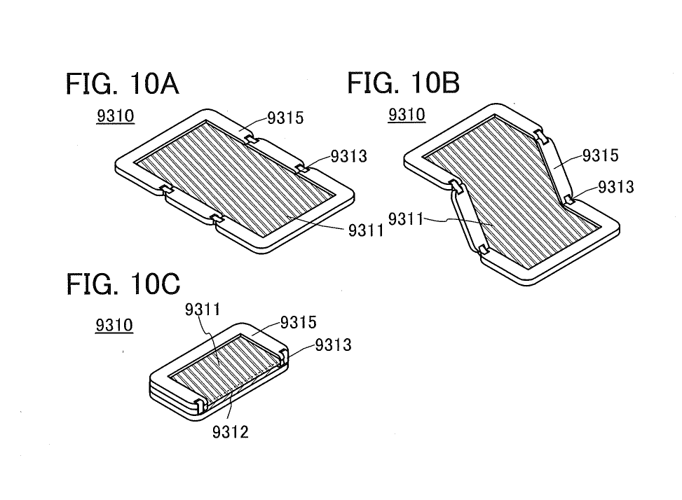

Examples of the electronic device including the display device are television devices (also referred to as TV or television receivers), monitors for computers and the like, cameras such as digital cameras and digital video cameras, digital photo frames, cellular phones (also referred to as mobile phones or portable telephone devices), portable game consoles, goggle-type displays (e.g., VR goggles), portable information terminals, audio playback devices, large game machines such as pachinko machines, and the like. Specific examples of the electronic devices are illustrated in FIGS. 9A, 9B, 9C, 9D, 9D′-1, 9D′-2, and 9E and FIGS. 10A to 10C.

FIG. 9A illustrates an example of a television device. In the television device 7100, a display portion 7103 is incorporated in a housing 7101. The display portion 7103 can display images and may be a touch panel (an input/output device) including a touch sensor (an input device). Note that the display device of one embodiment of the present invention can be used for the display portion 7103. In addition, here, the housing 7101 is supported by a stand 7105.

The television device 7100 can be operated by an operation switch of the housing 7101 or a separate remote controller 7110. With operation keys 7109 of the remote controller 7110, channels and volume can be controlled and images displayed on the display portion 7103 can be controlled. Furthermore, the remote controller 7110 may be provided with a display portion 7107 for displaying data output from the remote controller 7110.

Note that the television device 7100 is provided with a receiver, a modem, and the like. With the use of the receiver, general television broadcasts can be received. Moreover, when the television device is connected to a communication network with or without wires via the modem, one-way (from a sender to a receiver) or two-way (between a sender and a receiver or between receivers) information communication can be performed.

FIG. 9B illustrates a computer, which includes a main body 7201, a housing 7202, a display portion 7203, a keyboard 7204, an external connection port 7205, a pointing device 7206, and the like. Note that this computer can be manufactured using the display device of one embodiment of the present invention for the display portion 7203. The display portion 7203 may be a touch panel (an input/output device) including a touch sensor (an input device). Note that the computer can be especially suitable for outdoor use by including the display device of one embodiment of the present invention because a reduction in visibility due to reflection of external light can be prevented in the display device.

FIG. 9C illustrates a smart watch, which includes a housing 7302, a display portion 7304, operation buttons 7311 and 7312, a connection terminal 7313, a band 7321, a clasp 7322, and the like.

The display portion 7304 mounted in the housing 7302 serving as a bezel includes a non-rectangular display region. The display portion 7304 can display an icon 7305 indicating time, another icon 7306, and the like. The display portion 7304 may be a touch panel (an input/output device) including a touch sensor (an input device). Note that the smart watch can be especially suitable for outdoor use by including the display device of one embodiment of the present invention because a reduction in visibility due to reflection of external light can be prevented in the display device.

The smart watch illustrated in FIG. 9C can have a variety of functions, such as a function of displaying a variety of information (e.g., a still image, a moving image, and a text image) on a display portion, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading a program or data stored in a recording medium and displaying the program or data on a display portion.

The housing 7302 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the smart watch can be manufactured using the display device for the display portion 7304.

FIG. 9D illustrates an example of a cellular phone (e.g., smartphone). A cellular phone 7400 includes a housing 7401 provided with a display portion 7402, a microphone 7406, a speaker 7405, a camera 7407, an external connection portion 7404, an operation button 7403, and the like. In the case where a display device is manufactured by forming the liquid crystal element and the light-emitting element of embodiments of the present invention over a flexible substrate, the display device can be used for the display portion 7402 having a curved surface as illustrated in FIG. 9D.

When the display portion 7402 of the cellular phone 7400 illustrated in FIG. 9D is touched with a finger or the like, data can be input to the cellular phone 7400. In addition, operations such as making a call and composing e-mail can be performed by touch on the display portion 7402 with a finger or the like.

There are mainly three screen modes of the display portion 7402. The first mode is a display mode mainly for displaying an image. The second mode is an input mode mainly for inputting data such as characters. The third mode is a display-and-input mode in which two modes of the display mode and the input mode are combined.

For example, in the case of making a call or composing e-mail, a character input mode mainly for inputting characters is selected for the display portion 7402 so that characters displayed on the screen can be input. In this case, it is preferable to display a keyboard or number buttons on almost the entire screen of the display portion 7402.

When a detection device such as a gyroscope or an acceleration sensor is provided inside the cellular phone 7400, display on the screen of the display portion 7402 can be automatically changed by determining the orientation of the cellular phone 7400 (whether the cellular phone is placed horizontally or vertically for a landscape mode or a portrait mode).

The screen modes are changed by touch on the display portion 7402 or operation with the operation button 7403 of the housing 7401. The screen modes can be switched depending on the kind of images displayed on the display portion 7402. For example, when a signal of an image displayed on the display portion is a signal of moving image data, the screen mode is switched to the display mode. When the signal is a signal of text data, the screen mode is switched to the input mode.

Moreover, in the input mode, if a signal detected by an optical sensor in the display portion 7402 is detected and the input by touch on the display portion 7402 is not performed for a certain period, the screen mode may be controlled so as to be changed from the input mode to the display mode.

The display portion 7402 may function as an image sensor. For example, an image of a palm print, a fingerprint, or the like is taken by touch on the display portion 7402 with the palm or the finger, whereby personal authentication can be performed. In addition, by providing a backlight or a sensing light source that emits near-infrared light in the display portion, an image of a finger vein, a palm vein, or the like can be taken. Note that the cellular phone can be especially suitable for outdoor use by including the display device of one embodiment of the present invention in the display portion 7402 because a reduction in visibility due to reflection of external light can be prevented in the display device.

The display device can be used for a cellular phone having a structure illustrated in FIG. 9D′-1 or FIG. 9D′-2, which is another structure of the cellular phone (e.g., a smartphone).

Note that in the case of the structure illustrated in FIG. 9D′-1 or FIG. 9D′-2, text data, image data, or the like can be displayed on second screens 7502(1) and 7502(2) of housings 7500(1) and 7500(2) as well as first screens 7501(1) and 7501(2). Such a structure enables a user to easily see text data, image data, or the like displayed on the second screens 7502(1) and 7502(2) while the cellular phone is placed in user's breast pocket.

FIG. 9E shows a goggle-type display (a head-mounted display), which includes a main body 7601, a display portion 7602, and an arm portion 7603. Note that the goggle-type display can be especially suitable for outdoor use by including the display device of one embodiment of the present invention in the display portion 7602 because a reduction in visibility due to reflection of external light can be prevented.

Another electronic device including the display device is a foldable portable information terminal illustrated in FIGS. 10A to 10C. FIG. 10A illustrates a portable information terminal 9310 which is opened. FIG. 10B illustrates the portable information terminal 9310 which is being opened or being folded. FIG. 10C illustrates the portable information terminal 9310 which is folded. The portable information terminal 9310 is highly portable when folded. The portable information terminal 9310 is highly browsable when opened because of a seamless large display region.

A display portion 9311 is supported by three housings 9315 joined together by hinges 9313. Note that the display portion 9311 may be a touch panel (an input/output device) including a touch sensor (an input device). By bending the display portion 9311 at a connection portion between two housings 9315 with the use of the hinges 9313, the portable information terminal 9310 can be reversibly changed in shape from an opened state to a folded state. A display region 9312 in the display portion 9311 is a display region that is positioned at a side surface of the portable information terminal 9310 which is folded. On the display region 9312, information icons, file shortcuts of frequently used applications or programs, and the like can be displayed, and confirmation of information and start of application can be smoothly performed. Note that the portable information terminal can be especially suitable for outdoor use by including the display device of one embodiment of the present invention in the display portion 9311 because a reduction in visibility due to reflection of external light can be prevented in the display device.

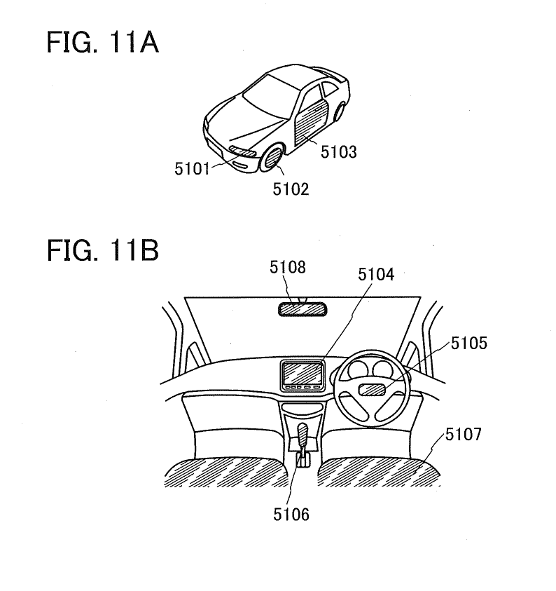

FIGS. 11A and 11B illustrate an automobile including the display device. The display device can be incorporated in the automobile, and specifically, can be included in lights 5101 (including lights of the rear part of the car), a wheel 5102 of a tire, a part or whole of a door 5103, or the like on the outer side of the automobile which is illustrated in FIG. 11A. The display device can also be included in a display portion 5104, a steering wheel 5105, a gear lever 5106, a seat 5107, an inner rearview mirror 5108, or the like on the inner side of the automobile which is illustrated in FIG. 11B, or in a part of a glass window. Note that the automobile can be especially suitable for outdoor use by including the display device of one embodiment of the present invention because a reduction in visibility due to reflection of external light can be prevented in the display device.

As described above, the electronic devices and automobiles can be obtained using the display device of one embodiment of the present invention. Note that the display device can be used for electronic devices and automobiles in a variety of fields without being limited to the electronic devices described in this embodiment.

Note that the structure described in this embodiment can be combined as appropriate with any of the structures described in other embodiments.

### Example 1

In this example, samples of the organic layer that functions as a polarizer (including the second organic layer in this specification) in the display device of one embodiment of the present invention were fabricated under various conditions, and the characteristics thereof were examined.

Fabrication of the samples is described below.

A dichroic dye (G241 produced by HAYASHIBARA CO., LTD.), the amount of which was different between the samples, was added to a liquid crystal (MLC-7030 produced by Merck) and mixing was performed. The mixture was injected into an antiparallel aligned cell with a cell gap of 2 μm, so that the sample in which the dichroic dye has uniaxial orientation was fabricated.

Next, the transmittance of the fabricated sample alone with respect to a wavelength of 550 nm was measured. For the measurement, an LCD evaluation system LCD-7200 produced by Otsuka Electronics Co., Ltd. was used. The maximum transmittance (Tₚ) and the minimum transmittance (T_{c}) when the sample was rotated were measured. For the measurement, a polarizing plate SKN-18243T produced by Polatechno Co., Ltd., whose degree of polarization (Vₐ) is known, was used as an analyzer. Note that the degree of polarization Vₛₐ of a combination of the sample and the analyzer can be calculated using Formula (1) below.

$$\begin{matrix}[ Formula 1 ] & \\ {V}_{sa} = \sqrt{\frac{{T}_{p} - {T}_{c}}{{T}_{p} + {T}_{c}}} & ( 1 )\end{matrix}$$

Furthermore, the degree of polarization Vₛ of the sample can be calculated by correcting the degree of polarization Vₛₐ using Vₐ as indicated by Formula (2) below.

$$\begin{matrix}[ Formula 2 ] & \\ {V}_{s} = {V}_{sa}^{2} \times \frac{1}{{V}_{a} } & ( 2 )\end{matrix}$$

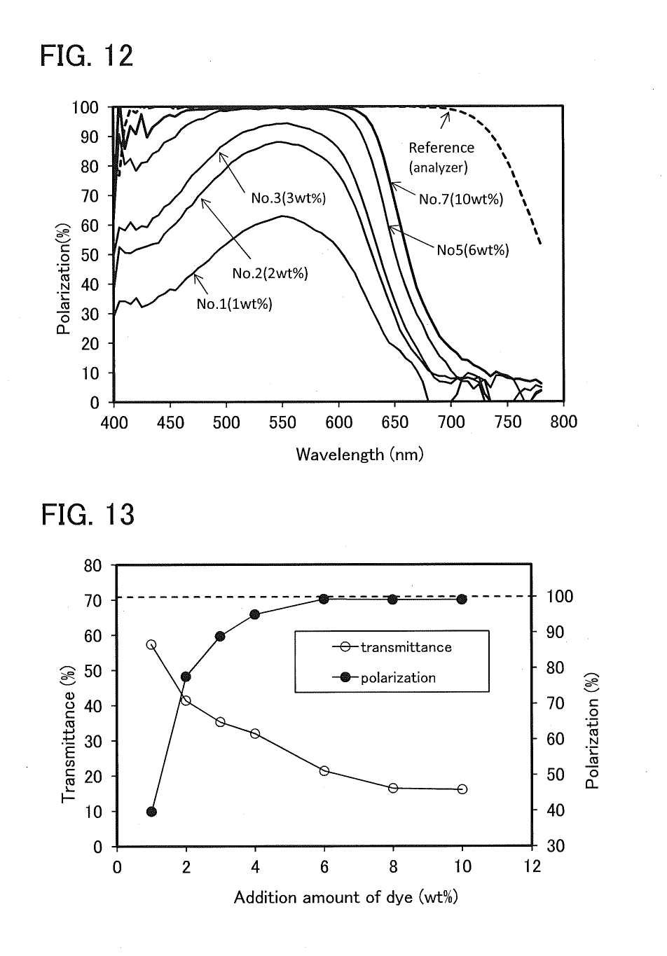

The relationship between the addition amount of the dichroic dye (wt %) and each of the transmittance (%) and the degree of polarization (%) of the samples calculated on the basis of the above formula is shown in Table 1 below, as well as the fabrication conditions of the samples. FIG. 12 shows the degree of polarization (%) of each of the samples as a function of wavelengths. Note that as a reference, a measurement result obtained when using the above analyzer is shown in FIG. 12. FIG. 13 shows the transmittance (%) and the degree of polarization (%) as a function of the addition amount of the dichroic dye.

TABLE 1

| | Addition amount | Transmittance | Degree of polarization |
|---|---|---|---|
| Sample | (wt %) | (%) | (%) |
| No. 1 | 1 | 57.4 | 39.8 |
| No. 2 | 2 | 41.4 | 77.6 |
| No. 3 | 3 | 35.3 | 89 |
| No. 4 | 4 | 32.0 | 95 |
| No. 5 | 6 | 21.4 | 99.3 |
| No. 6 | 8 | 16.4 | 99.2 |
| No. 7 | 10 | 16.1 | 99.2 |

These results show that the degree of polarization increases with an increase in the addition amount of the dichroic dye. For example, the degree of polarization of the samples in which the dichroic dye was added at greater than or equal to 3 wt % was approximately greater than or equal to 90%.

However, a higher addition amount of the dichroic dye leads to not only a higher degree of polarization but also a reduced transmittance; therefore, it is necessary to add the dichroic dye such that the transmittance and the degree of polarization are high enough to enable a function of a polarizer. Thus, when the organic layer of the display device of one embodiment of the present invention is formed using the material described in this example, the addition amount of the dichroic dye is set within a range of 2 wt % to 6 wt %, whereby both the transmittance and the degree of polarization can have favorable values.

### REFERENCE NUMERALS

101: first substrate, 102: second substrate, 103: element layer, 103a: driving element layer, 103b: display element layer (L), 103c: display element layer (E), 104: organic layer, 104a first organic layer, 104b: second organic layer, 105: first organic layer, 105a and 105b: alignment film, 106: retardation layer, 200: first substrate, 201: organic layer, 202: transistor, 203: liquid crystal element, 204: liquid crystal layer, 205: second substrate, 207: first electrode, 208: second electrode, 209: spacer, 210: alignment film, 211: alignment film, 212: retardation layer, 213: color filter, 214: black layer (black matrix), 215: overcoat layer, 216: diffusion layer, 217: insulating layer, 218: insulating layer, 220: terminal portion, 221: FPC, 222: connection layer, 230: pixel portion, 231: pixel, 232: liquid crystal element, 233: transistor, 234: capacitor, 240: control portion, 241: display portion, 250: S driver circuit, 251: G driver circuit, 300: first substrate, 301: organic layer, 301a: first organic layer, 301b: second organic layer, 302: transistor (FET), 303, 303R, 303G, 303B, and 303W: light-emitting element, 304: EL layer, 305: second substrate, 306R, 306G, and 306B: optical path length, 307: first electrode, 308: second electrode, 309: wiring, 310R: conductive layer, 310G: conductive layer, 311R, 311G, 311B: color filter, 312: insulator, 313: element layer, 313a: driving element layer, 313b: display element layer, 314: retardation layer, 401: first electrode, 402: second electrode, 403: EL layer, 403a and 403b: EL layer, 404: charge generation layer, 411, 411a, and 411b: hole-injection layer, 412, 412a, and 412b: hole-transport layer, 413, 413a, and 413b: light-emitting layer, 414, 414a, and 414b: electron-transport layer, 415, 415a, and 415b: electron-injection layer, 501: first substrate, 502: pixel portion, 503: driver circuit portion, 504a, 504b: driver circuit portion, 505: sealant, 506: second substrate, 507: lead wiring, 508: FPC (flexible printed circuit), 509: FET, 510: FET, 511: FET (switching FET), 512: FET (current control FET), 513: first electrode, 515: EL layer, 516: second electrode, 517: light-emitting element, 518: space, 520: organic layer, 520a: first organic layer, 520b: second organic layer, 521: retardation layer, 600: first substrate, 601: organic layer, 601a: first organic layer, 601b: second organic layer, 603: light-emitting element, 604: liquid crystal element, 605: second substrate, 607: first electrode, 608: conductive layer, 615: transistor, 616: transistor, 617: transistor, 618: terminal portion, 619: terminal portion, 628: coloring layer, 630: conductive layer, 631: EL layer, 632: conductive layer, 633: opening, 634: coloring layer, 635: light-blocking layer, 636: spacer, 638: liquid crystal layer, 640: alignment film, 641: alignment film, 642: bonding layer, 644: FPC, 645: connection layer, 647: connection portion, 648: connector, 650: first element layer, 651: second element layer, 652: third element layer, 653: retardation layer, 654: diffusion layer, 655: insulating layer, 656: insulating layer, 701: circuit (G), 702: circuit (S), 703: display portion, 704: pixel, 705: conductive film, 707: opening, 5101: light, 5102: wheel, 5103: door, 5104: display portion, 5105: steering wheel, 5106: gear lever, 5107: seat, 5108: inner rearview mirror, 7100: television device, 7101: housing, 7103: display portion, 7105: stand, 7107: display portion, 7109: operation key, 7110: remote controller, 7201: main body, 7202: housing, 7203: display portion, 7204: keyboard, 7205: external connection port, 7206: pointing device, 7302: housing, 7304: display portion, 7305: icon indicating time, 7306: another icon, 7311: operation button, 7312: operation button, 7313: connection terminal, 7321: band, 7322: clasp, 7400: cellular phone, 7401: housing, 7402: display portion, 7403: operation button, 7404: external connection portion, 7405: speaker, 7406: microphone, 7407: camera, 7500(1) and 7500(2): housing, 7501(1) and 7501(2): first screen, 7502(1) and 7502(2): second screen, 7601: main body, 7602: display portion, 7603: arm portion, 9310: portable information terminal, 9311: display portion, 9312: display region, 9313: hinge, 9315: housing

This application is based on Japanese Patent Application serial no. 2016-131938 filed with Japan Patent Office on Jul. 1, 2016, the entire contents of which are hereby incorporated by reference.

1. A display device comprising:
an element layer over a first substrate;
a retardation layer over the element layer;
a first organic layer and a second organic layer over the retardation layer; and
a second substrate over the first organic layer and the second organic layer,
wherein the element layer comprises a liquid crystal element and a light-emitting element,
wherein the first organic layer comprises a material with a light-transmitting property,
wherein the second organic layer comprises a dichroic dye in which major axes of molecules are oriented in one predetermined direction,
wherein the first organic layer and the light-emitting element overlap with each other, and
wherein the second organic layer and the liquid crystal element overlap with each other.

2. The display device according to claim 1, wherein the element layer further comprises a first driving element electrically connected to the liquid crystal element, and a second driving element electrically connected to the light-emitting element.

3. The display device according to claim 1,
wherein the element layer further comprises a first driving element electrically connected to the liquid crystal element, and a second driving element electrically connected to the light-emitting element,
wherein the second organic layer and the first driving element overlap with each other, and
wherein the second organic layer and the second driving element overlap with each other.

4. The display device according to claim 1, wherein the second organic layer further comprises a liquid crystalline polymer.

5. The display device according to claim 1, wherein the second organic layer further comprises a liquid crystal and a polymer.

6. The display device according to claim 1,
wherein the dichroic dye is represented by any one of Structural Formulae (101) to (105).

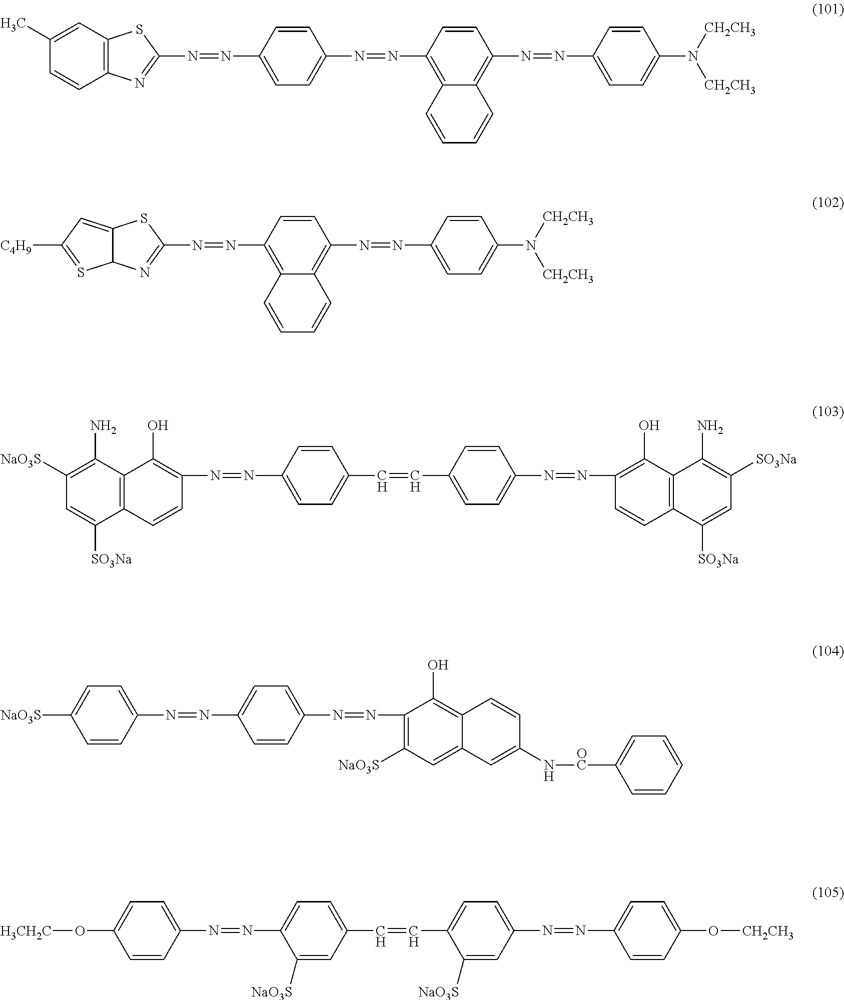

7. An electronic device comprising the display device according to claim 1.

8. A display device comprising:
an element layer over a first substrate;
a retardation layer over the element layer;
an organic layer over the retardation layer; and
a second substrate over the organic layer,
wherein the element layer comprises a liquid crystal element,
wherein the organic layer comprises a dichroic dye in which major axes of molecules are oriented in one predetermined direction, and
wherein the organic layer and the liquid crystal element overlap with each other.

9. The display device according to claim 8,
wherein the second substrate comprises a material transmitting visible light, and
wherein the liquid crystal element is a reflective liquid crystal element from which light is emitted to the second substrate side.

10. The display device according to claim 8, wherein the organic layer further comprises a liquid crystalline polymer.

11. The display device according to claim 8, wherein the organic layer further comprises a liquid crystal and a polymer.

12. The display device according to claim 8,
wherein the dichroic dye is represented by any one of Structural Formulae (101) to (105).

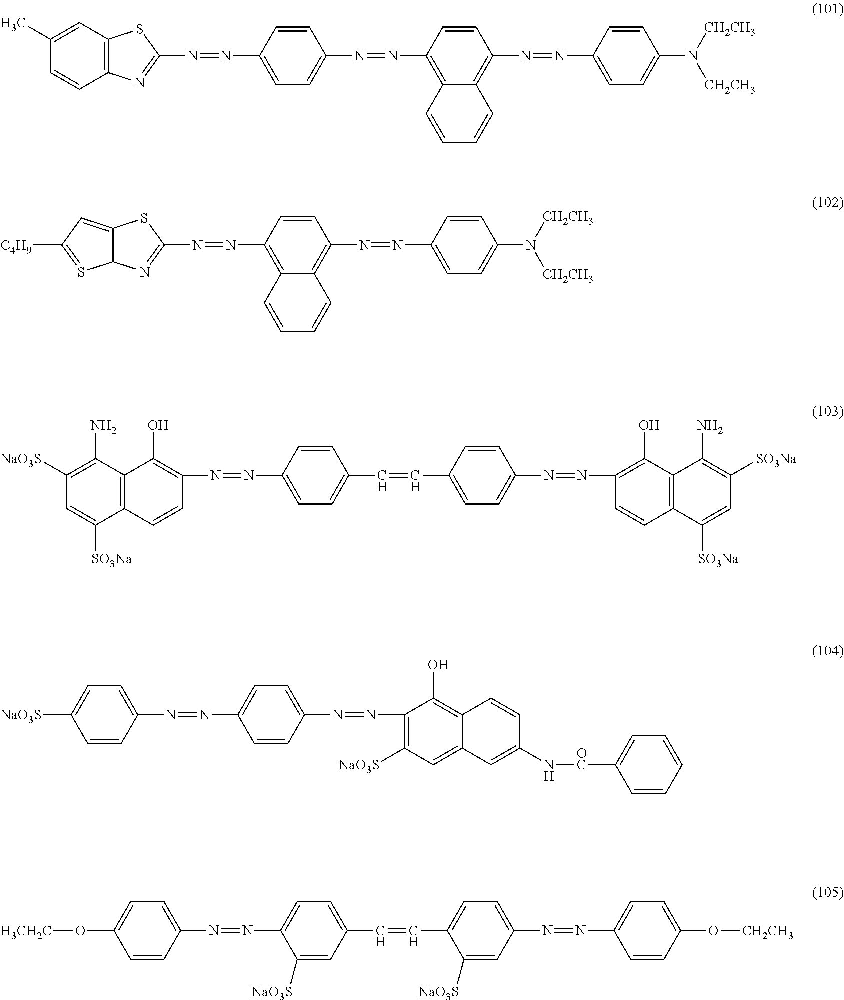

13. An electronic device comprising the display device according to claim 8.

14. A display device comprising:
an element layer over a first substrate;
a retardation layer over the element layer;
a first organic layer and a second organic layer over the retardation layer; and
a second substrate over the first organic layer and the second organic layer,
wherein the element layer comprises a light-emitting element, a driving element, and a wiring,
wherein the first organic layer comprises a material with a light-transmitting property,
wherein the second organic layer comprises a dichroic dye in which major axes of molecules are oriented in one predetermined direction,
wherein the first organic layer and the light-emitting element overlap with each other, and
wherein the second organic layer and the wiring overlap with each other.

15. The display device according to claim 14, wherein the light-emitting element is electrically connected to the driving element through the wiring.

16. The display device according to claim 14, wherein the light-emitting element is configured to emit light to the second substrate side.

17. The display device according to claim 14,
wherein the light-emitting element comprises an EL layer between an anode and a cathode, and
wherein light emitted in the EL layer is transmitted through the anode and emitted from the second substrate side.

18. The display device according to claim 14,
wherein the light-emitting element comprises an EL layer between an anode and a cathode, and
wherein the EL layer comprises a first EL layer, a charge generation layer over the first EL layer, and a second EL layer over the charge generation layer.

19. The display device according to claim 14, wherein the second organic layer further comprises a liquid crystalline polymer.

20. The display device according to claim 14, wherein the second organic layer further comprises a liquid crystal and a polymer.

21. The display device according to claim 14,
wherein the dichroic dye is represented by any one of Structural Formulae (101) to (105).

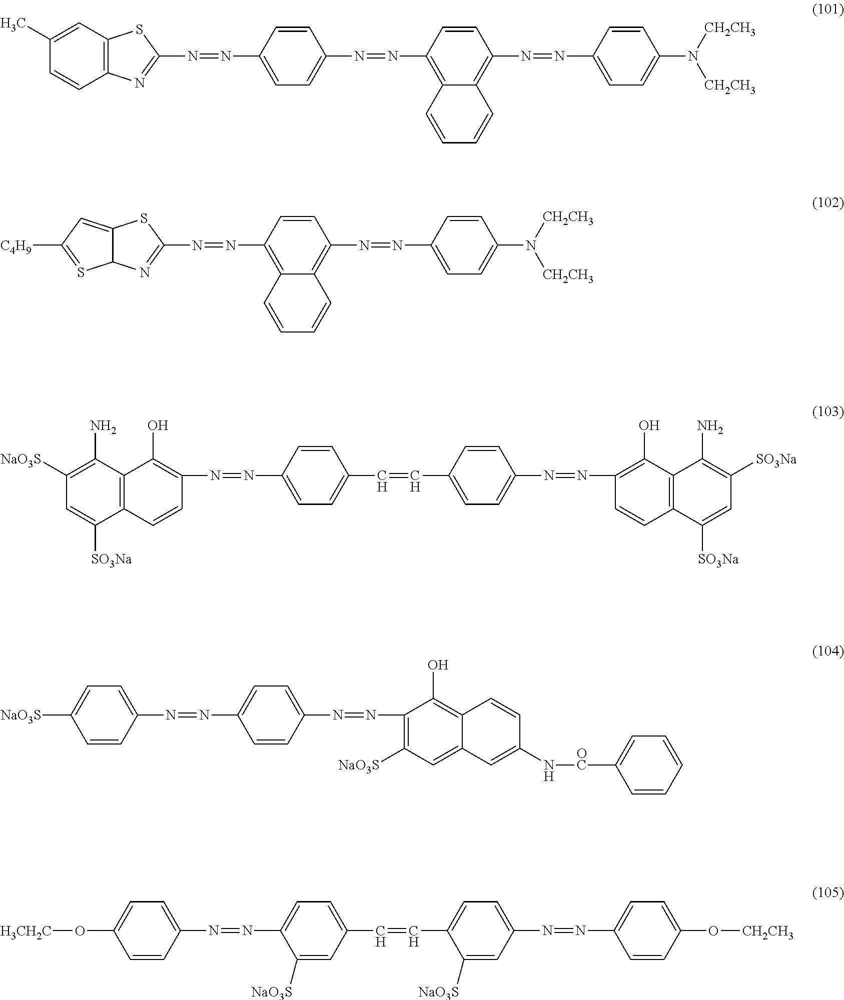

22. An electronic device comprising the display device according to claim 14.
